(19) United States
(12) Patent Application Publication
(10) Pub. No.: US 2025/0311715 A1
(43) Pub. Date: Oct. 9, 2025

(54) PULSE WIDTH MODULATION FOR DOSE RATE ADAPTION

(71) Applicant: BASF Agro Trademarks GmbH, Ludwigshafen am Rhein (DE)

(72) Inventors: Clemens Christian DELATREE, Muenster (DE); Daniel EBERSOLD, Limburgerhof (DE); Bruno CANELLA VIEIRA, Koeln (DE); Greg Robert KRUGER, Durham, NC (US)

(21) Appl. No.: 18/873,189

(22) PCT Filed: Jun. 6, 2023
(86) PCT No.: PCT/EP2023/065059

§ 371 Date: Dec. 9, 2024

(30) Foreign Application Priority Data
Jun. 7, 2022 (EP) 22177419.3

(51) Int. Cl. A01M 7/00; A01M 21/04; B05B 12/16; G06V 20/10

(52) U.S. Cl. CPC A01M 7/0092; A01M 7/0042; A01M 21/043; B05B 12/16; G06V 20/188

(57) ABSTRACT

Method for generating a control signal for a smart spraying device with at least one individual spray nozzle, and a method for controlling a smart spraying device, using PWM and field data relating to a vegetative indicator for providing an improved adaptive application of products onto an area to be treated.

### FIELD OF THE INVENTION

The present invention relates to a method for generating a control signal for a smart spraying device, a method for controlling a smart spraying device, a computer program product being adapted for carrying out aforementioned method, a computer storage medium having stored thereon the aforementioned computer program product as well as respective corresponding computer implemented methods which provide for an improved adaptive application of products onto an area to be treated.

### BACKGROUND OF THE INVENTION

In recent years, a trend has emerged for farming machinery such as sprayers, harvesters, or seeders to allow for more targeted operations on farming fields. Thus far, in particular, with respect sprayers and pesticide applications broadcast spraying has been the norm. Such non-targeted techniques are however inefficient. To increase efficiency by reducing the amount of treatment products applied to the field, smart spraying technologies are evolving. These allow detecting conditions in the field and based on such detection control spot spraying operations.

For instance, in weed control through a chemical weed control agent, the sprayer is equipped with a camera system that takes images while the sprayer traverses through the field. Real-time image analysis allows for weed detection and targeted spray operations. Such a system is for instance described in EP3741214A1.

### SUMMARY OF THE INVENTION

The present invention provides a method for generating a control signal for a smart spraying device, a method for controlling a smart spraying device, a computer program product being adapted for carrying out aforementioned method, a computer storage medium having stored thereon the aforementioned computer program product according to any of the independent claims as well as a corresponding computer implemented method, wherein exemplary embodiments are incorporated in the dependent claims.

According to an embodiment, there is provided a method for generating a control signal for a smart spraying device with one or more individually controllable spray nozzle(s) or groups of spray nozzles, the method comprises receiving a vegetative indicator of an area to be treated, determining a required dose rate for a first product for an area to be treated with a first product based on the vegetative indicator, determining a first duty cycle of a PWM of a control signal for application of the first product in the area to be treated based on the determined dose rate for the first product, wherein the first duty cycle is indicative of an activation duration during a duration of a first base cycle for at least one of the individually controllable spray nozzle(s), providing the generated control signal for individually controlling said one or more spray nozzle(s) or group of spray nozzles (28, 28.1) for application of the first product (23). According to an embodiment, determining a first duty cycle of a PWM of a control signal is carried out to arrive at an actual application rate corresponding the determined dose rate.

Thus, it is possible to generate controlling signals for a spraying device for applying a product, e.g., a herbicide, based on vegetation on the field and the area to be treated by applying a pulse width modulation PWM for the signal for controlling a nozzle of a treatment device. Using PWM Nozzles instead of pressure nozzles allows for easier and more reliable adjustment. As smart sprayers upon variable rate application from e.g., a predetermined application map requires an intermittent change of a dose rate during movement over a field, easier and more reliable adjustment of the nozzles leads to a more reliable application of a product. Thus, using a PWM controlled nozzle with the pulse width as variable is more reliable than e.g., pressure controlled nozzles with pressure as variable. Further, it should be noted that a more exact control of the dose rate allows more targeted and reliable treatment in the field. As far as a control of a nozzle is mentioned in the following, usually a control of a valve is included which controls the feeding of a product to a nozzle connected to the valve. The pulse width modulation PWM is based on the determination of a length of a first duty cycle of a control signal indicative of an on-state. The duration of the on-state during a base cycle or clock cycle compared to the length of the total base cycle or clock cycle represents a ratio of an on-duration and a total duration. As pressure controlled nozzles or a partial activation of a nozzle and nozzle valve, respectively, may cause an indifferent spraying characteristic and undesired droplets, a full activation in the meaning of a full opening state may avoid such indifferent characteristic and droplets. For the application of a particular intended dose rate instead of permanently activating the nozzle in an intermediate opening state corresponding to the dose rate, PWM is applied, where the ratio of the duration of the duty cycle and the duration of the base cycle or clock cycle corresponds to the intended dose rate. The start/stop effects upon activation of a nozzle are more predictable than the indifferent state of a partially activated nozzle. By applying the PWM the actually applied rate for a product corresponds to the determined dose rate. Application of PWM considers the field data relating to (a) vegetative indicator(s), so that the PWM may be applied dynamically based on the condition on the field.

According to an embodiment, receiving a vegetative indicator of the area to be treated includes receiving location-specific field data associated with a plurality of sub-areas within the area to be treated, wherein determining a required dose rate for a first product includes determining an individual dose rate for the respective sub-area to be treated based on the vegetative indicator associated with the respective sub-area, wherein determining a first duty cycle of a control signal includes determining a first duty cycle for at least one of the individually controllable spray nozzle(s) or group of spray nozzles based on the individual dose rate for the first product for the respective sub-area, wherein providing the generated control signal includes providing a generated control signal for at least one of the individually controllable spray nozzle(s) or group of spray nozzles for application of the first product in the respective sub-area.

Thus, it is possible to generate control signals also based on a geo-location specific condition. Allocation of a group of nozzles or even a single nozzle to a particular part of the field, e.g., a sub-area to be treated allows different treatment for different sub areas and thus considering particular need for particular geo-locations upon the respective condition or vegetative indicator on that geo-location in the respective sub-area. The generated signal may be different for each nozzle (group) associated with a particular sub-area. Per sub-area the actual application rate may be adapted to correspond to the intended dose rate for that sub-area and may vary along the extension of the sub-area in order to consider different needs for different geo-locations along the respective sub-area. As the PWM has a more predictable characteristic than a variable activation level, in particular a pressure based nozzle system, the exactness of the application of a particular product may be increased. This is particularly relevant if the total application rate on a field underlies regulatory limits. Thus, the more exact application of a product allows a more reliable application within the regulatory limits. This also applies for application of different products falling under the same regulatory limit, so that one product upon detection of a particular parameter in the vegetative indicator may be applied in a stronger concentration, whereas another product is reduced in concentration at the same time. Also a shift of stronger and less stronger concentrations or dose rates from one sub-area to another sub-area can be applied while maintaining the total regulatory level over the total area of multiple sub-areas.

According to an embodiment, the method further comprises receiving a ground speed of the at least one spray nozzle or group of spray nozzles, wherein determining a first duty cycle of a control signal includes determining a first duty cycle for at least one of the individually controllable spray nozzles or group of spray nozzles for application of the first product in an area to be treated, based on the determined dose rate for a first product and the ground speed of the at least one spray nozzle or group of spray nozzles.

Thus, the dose rate can be maintained even upon varying ground speeds. The variation of the ground speed may be compensated by adapting the duration of the duty cycle, so that the absolute applied dose varies, but the dose rate, a particular amount of product per area, remains the same. Consequently, the duration of the duty cycle may be adopted not only based on the location-specific field data and vegetative indicator, but based on a combination of the ground speed and the location-specific field data including the vegetative indicator.

According to an embodiment receiving a ground speed includes receiving an individual ground speed for individual spray nozzles or groups of spray nozzles each associated with a respective sub-area, wherein determining a first duty cycle of a control signal in particular includes determining a first duty cycle for individual spray nozzles or group of spray nozzles based on the individual dose rate for the first product for the respective sub-area and the individual ground speed of the individual spray nozzles or group of spray nozzles.

Thus, also a variable ground speed may be considered for generating a control signal for a nozzle or spray nozzle group at an intended dose rate. A variable ground speed may occur due to different driving speed of the treatment device or upon curved tracks, where the outer nozzle has a higher ground speed compared to the inner nozzle. When applying the same duration of the duty cycle, without adoption, the inner nozzle will apply a higher dose rate, as it covers a lower area at the same absolute dose application. This can be compensated with adopting the duration of the duty cycle. Consequently, the duration of the duty cycle may be adopted not only based on the geo-specific field data and vegetative indicator, but based on a combination of the respective geo-location specific ground speed and the geo-specific field data including the vegetative indicator.

According to an embodiment the dose rate for the respective sub-area is determined based on a model or look-up table, wherein the model or the look-up table assigns a correspondence between a vegetative indicator as at least one of a weed indicator of a weed type or weed species, pest indicator of a pest type or pest species or a disease indicator, of a disease type and the dose rate for the respective sub-area. A look-up table is not limited to a one-to-one association of an indicator and a product or product dose rate. A look-up table may be represented by a data driven model, considering also combinatory effects of different indicators and synergetic effects of different products. A look-up table may have the form of an algorithm.

Thus, a dose rate may be derived from a relation of a particular parameter of a vegetative indicator on the one hand and a corresponding dose rate on the other hand. The dose rate may be determined based on different kinds of parameters, e.g., parameters relating to weeds, parameters relating to pests, parameters relating to diseases, or any combination thereof. The look-up table may include immediate relations between a single parameter, a particular product, which may be selected for application and a dose rate thereof. The look-up table may also include a multi-dimensional relation between parameter combinations and a particular product and its corresponding dose rate, and/or a relation between parameter combinations and product combinations and corresponding combinations of respective dose rates. Based on the vegetative indicator, in particular different indicators included in the vegetative indicator, a product or product combination selection may be carried out. The look-up table may provide a concatenation of different indicators which may be used for a respective product or product combination selection based on a product ID in the look-up table. A vegetative indicator, e.g., a weed species indicator may lead to a particular product selection and provide a product ID, a further indicator, e.g., an indicator relating to a weed density of that indicated weed species may provide a dose rate for that indicator and product.

According to an embodiment, determining a required dose rate includes identification of a particular product or a combination of products out of a group of products as the first product, and determining a respective dose rate for each of the identified products based on the vegetative indicator of the respective location-specific field data of the respective area or sub-area to be treated.

Thus, not only a predefined product may be applied, but also a suitable product may be identified based on a look-up table as described above. Thus, control signals may be generated for a more adaptive treatment regarding a product selection or product combination selection. It should be noted that such look-up table may also consider a combinatory effect of different products which may extend over the sum of single effects of the singe products.

According to an embodiment, the field data comprises real time field data associated with a real-time condition of a geo-location within an area to be treated.

Thus, generation of a control signal can be based on the actual field condition and the actual filed properties, so that treatment of the area can based on real time conditions of the field.

According to an embodiment, the real time field data comprise real time field image data representing a vegetative indicator of a geo-location within an area to be treated, wherein the method comprises deriving the vegetative indicator from real time field image data.

Thus, the generation of controlling signals can be based on real time imaging of the field to be treated. Real time image data can be obtained from monitoring devices on the sprayer device to be controlled. Images may be obtained from camera devices being allocated to the sub-areas, whereas the image of a particular camera of a sub-area is used to generate the control signal for that nozzle or nozzle group, which is allocated to the same sub-area. Image data of different cameras may be correlated to interpret the respective image content. Image data may include data from cameras on different spectra, e.g., infrared, visible light, ultraviolet. Image data may also be obtained from cameras using an active radiation of the area to be imaged, so as to detect a response or reflection spectrum of the radiated spectrum.

According to an embodiment, the respective control signal is provided if a vegetative indicator with respect to a quantitative value indicates a treatment condition for treatment with the first product. According to an embodiment, an indication may be provided by comparison to a threshold of a quantitative value, which may exceed or fall below a threshold.

According to an embodiment, the control signal per nozzle relates to an active-operation, if the vegetative indicator related to a specific nozzle is a quantitative indicator and with respect to a first threshold of the respective vegetative indicator indicates the respective sub-area to be treated with the first product.

Thus, a treatment of an area can be carried out only if a particular indicator is identified. In general, the indicator may signify a field condition and required treatment. The indicator may relate to species/type or quantitative value. The indicator may be an identification indicator, e.g., a weed type or weed species, a pest type etc., or the indicator may be a level or quantitative indicator, e.g., a level or quantity of weeds, pests, diseases etc. If an indicator indicates a species or type, then an activation of an application may be initiated based on a particular species or type provided by indicator. If quantitative value or level is indicated, then an activation of an application may be initiated based on a value with respect to e.g., a threshold. In combination with a real time field data, in particular a real time image field data, an application of a particular product is only activated, if the actual real time condition of the area to be treated requires a treatment. This threshold may be applied also for an additional, e.g., second product for a particular weed, so that the second product is only applied if e.g., a critical weed extends a level or threshold.

According to an embodiment, determining the first duty cycle includes determining or modifying the duration of the respective first base cycle by providing a predetermined overlap of application areas of the first product between applications of the first product in successive duty cycles. According to an embodiment a predetermined overlap of application areas of the first product between applications of the first product in successive duty cycles is maintained in a movement direction of the respective spray nozzle or spray nozzle group. According to an embodiment, providing a predetermined overlap of at least two application areas in successive duty cycles is provided for respective sub-areas in movement direction of the individual spray nozzle or group of spray nozzles, wherein the first base cycle is derived from the predetermined overlap of application areas in successive duty cycles and from the on duration of the first duty cycle derived from the dose rate.

Thus, a reliable application of a product can be achieved, when applying a PWM. PWM has the characteristic, that there are activated periods and gaps of not activated periods. Depending on the ground speed and the duration of the duty cycle, this may lead to gaps in treatment. A spray area usually has the shape of a cone or a pyramid, with the area to be treated being the base of the cone or pyramid. If the cone or pyramid is narrow, and the sides or flanks thereof are steep (which may be desired to have a sharp designed treatment area), upon high ground speeds the gaps between the duty cycles may become too long, in particular when treating critical weeds. In such cases the treatment may not hit the critical weed, if it is within the gap and does not extend into the treatment cone or pyramid. As it should be avoided to elongate the duty cycle, as this would result in a higher dose rate than intended, as an alternative, the duration of the base cycle or clock cycle can be reduced, while maintaining the ratio between the duration of the duty cycle and the duration of the base cycle. Thus, the dose rate corresponding to the ratio remains the same, but the gaps may be reduced to a size, which guarantees treatment of critical weeds also in the gap area. Because of the cone/pyramid characteristic, two application areas in successive cycles may have an overlap. If the overlap is positive, i.e., a particular area is treated in one duty cycle as well as in a succeeding duty cycle, no gap occurs. If the overlap is negative, which in this context should mean that there is no double treatment in successive duty cycles and a gap between both subsequently treated areas occurs, the negative overlap should be kept small, i.e., the gap should be kept small, so that no critical weed is left out in treatment. If a product is used, for which it is sufficient that it hits the weed anywhere but not overall, then the gap and negative overlap should be smaller than the minimum size of critical weed size which should be subject to treatment.

According to an embodiment, the vegetative indicator associated with the respective sub-area is at least one weed indicator out of a group, including a total weed density, a weed type and/or weed species, a weed density of a particular weed type and/or weed species, a weed quantity, a location specific clustered weed density, a weed growth stage, and a weed size. According to an embodiment, the vegetative indicator includes multiple parameters out of a group, the group including a total weed density, a weed type and/or weed species, a weed density of a particular weed type and/or weed species, a weed quantity, a location specific clustered weed density, a weed growth stage, and a weed size.

Thus, in particular weed specific parameters may be applied for determining a dose rate and generating a control signal based thereon. Some of the weed indicators may be used for selecting a particular product, e.g., a product, which is adapted to treat particular weed types and weed species. Other weed indicators may be used for determining the dose rate, as they require a particular amount to develop the intended effect, e.g., indicators relating to a weed density. Some of the weed parameters may be indicative for a combination of a particular product and the dose rate, e.g., a weed density of a particular weed type and/or weed species, a plantation location specific clustered weed density, a weed growth stage, and a weed size. It should be noted that the allocation of the respective weed indicator to the selection of a product and/or the determination of the dose rate may also depend on the working effect of the product, e.g., whether it is sufficient to spot the weed somewhere or anywhere.

According to an embodiment, the vegetative parameter includes a type or species parameter specifying a condition per sub-area and a quantitative parameter specifying a quantity of a type or species per sub-area, wherein the method further comprises selecting the first product per sub-area based on the type or species parameter, wherein determining dose rate per sub-area is based on at least one of the type or species parameter and the quantitative parameter.

Thus, the product selection may be tailored to the respective sub-area and to the type or species of a weed, a pest, or a kind of disease. Not only the product, which also includes a product combination, may be selected, but also the dose rate. The dose rate may be determined based in the determined quantity of the type or species for which the product was identified. Determining a dose also includes determining a plurality of single dose rates for singe products which then are combined as the afore mentioned product combination.

According to an embodiment, the respective vegetative indicator is at least one out of a group, including a disease type, a pest population, a pest feeding damage, a damage related color change, a plant stress indicator, and a density of crop.

Thus, also other indicators of specific parameters may be applied for determining a dose rate and generating a control signal based thereon. It should be noted that the allocation of the respective indicator to the selection of a product and/or the determination of the dose rate may also depend on the working effect of the product, e.g., whether it is sufficient to spot the crop somewhere or anywhere. It should be noted that also a combination of weed indicators and non-weed indicators may be used for identification of the suitable product and dose rate, in particular if a non-weed indicator is indirectly indicative of a weed parameter, e.g., for a particular pest indicator it is known that it occurs at a particular weed.

According to an embodiment, the vegetative indicator is derived from real time field data collected during treatment of the field, wherein the field data are associated with a field condition, wherein determining a duration of the first duty cycle is determined in real time based on the vegetative indicator per sub-area and location specific dose rates per sub-area per spray nozzle or spray nozzle group. According to an embodiment, the real time field data are real time image field data.

Thus, generating a control signal for the respective nozzle or nozzle group can be carried out under real time condition of the field, in particular a real time condition in each sub-area. A sensor device, in particular an imaging device can be provided for a respective nozzle or nozzle group and the data obtained from that image device may serve as a basis for determining a respective control signal for that nozzle or nozzle group. The sensor device or imaging device may be arranged in an intended movement direction over the field shortly before the nozzle or nozzle group. Thus, the short time when the sprayer device moves over the field between the time when the imaging device takes an image and the time when the nozzle or nozzle group arrives at the location where the imaging device has taken the image can be used to run a respective process cycle for determining the control signal for the respective nozzle or nozzle group. This is still considered as a real time processing.

According to an embodiment, determining a dose rate comprises determining a dose rate based on a vegetative indicator associated with the respective sub-area derived from a plantation growth model to vegetative parameters recognized from the respective field data.

Thus, a dose rate may be derived from a relation of a particular parameter of a vegetative indicator on the one hand and a corresponding dose rate on the other hand implemented in a plantation growing model. The dose rate may be determined based on different kinds of parameters, parameter relating to weeds, parameter relating to pests, parameter relating to diseases, or any combination thereof. The plantation growing model may have implemented immediate relations between a single parameter, a particular product, which may be selected for application and a dose rate thereof. The plantation growing model may also include a multi-dimensional relation between parameter combinations and a particular product and its corresponding dose rate, or a relation between parameter combinations and product combinations and corresponding combinations of respective dose rates.

According to an embodiment, the method further comprises determining a weed indicator per sub-area associated with a predetermined weed type and/or weed species based on the field data of that respective sub-area, adapting the required dose rate for a first product applied to the respective sub-area based on the determined weed indicator.

Thus, a predetermined weed can be identified, which predetermined weed may be a particularly critical weed, which requires a particular treatment. From some critical weeds it is known that they lead to a significant damage, so that their identification is of particular interest. Upon detection of such critical weed, the dose of the product is adapted, e.g., increased. This increase may be applied specific to a geo-location upon detection of the critical weed in that geo-location. Thus, the adaption of the dose rate for the product can be carried out based on geo-location specific field data, in particular geo-location specific image field data obtained in real time from imaging devices, e.g., cameras.

According to an embodiment, the method further comprises identifying in the vegetative indicator a particular type or species parameter specifying a condition per sub-area and a quantitative parameter specifying a quantity of that type or species per sub-area, identifying a second product based on the identified particular type or species parameter, determining a required dose rate for the second product for a sub-area for which in the vegetative indicator a particular type or species parameter was identified based on the identified quantitative parameter, determining a second duty cycle of a PWM of a control signal for application of the second product in the respective sub-area for which in the vegetative indicator a particular type or species parameter was identified based on the determined dose rate for the second product, wherein the second duty cycle is indicative of an activation duration during a duration of a second base cycle for at least one of the individually controllable spray nozzle(s) or spray nozzle groups associated to the sub-areas for which in the vegetative indicator a particular type or species parameter was identified, providing the generated control signal for controlling the respective spray nozzle or spray nozzle group for the respective sub-area for application of the second product (24).

Thus, a particular filed condition can be identified, e.g., a predetermined weed can be identified, which predetermined weed may be a particularly critical weed, which requires a particular treatment. Upon detection of such critical weed, a second product is applied to that weed in the sub-area where this weed was identified. The method may comprise selecting a particular product or product combination as the second product and the respective dose thereof. The application of the second product, in particular the selection of a product or product combination may be applied specific to a geo-location upon detection of the critical weed in that geo-location. Thus, the application of the second product with a specific dose rate for the second product can be carried out based on geo-location specific field data, in particular geo-location specific image field data obtained in real time from imaging devices, e.g., cameras. The application of a second product also applies for other particular conditions in the field, e.g., identification of a critical pest, a critical disease or also a nutrition condition or a growth stage condition of the crop for application of a nutrition product. It should be noted that the duration of the first and second duty cycle may be of the same length and that also the duration of the first and second base cycle may be of the same length. As a default, the duration of the second duty cycle may be set to the duration of the first duty cycle, and/or the duration of the second base cycle may be set to the duration of the first base cycle.

According to an embodiment, determining a first duty cycle includes a per sub-area related determining of a first duty cycle based on application map field data provided prior to the field treatment process, wherein determining a second duty cycle includes determining of a second duty cycle for sub-areas where a particular type or species parameter was identified based on real time field data obtained during the field treatment process.

Thus, a rather generic broadcast of a first product may be applied with different application rates, where the PWM allows an exact dosage and application pattern specific for the respective sub-areas depending on data which were collected prior to the treatment on the field. Such data may come from satellite data, historical data collected during an earlier field treatment, or the like. Nevertheless, a particular situation on the filed specific for a particular location on the field can be identified, which may require a particular treatment, as. e.g., a critical weed was identified, which by nature was not included in earlier collected data. Real time identification allows a reaction on the particular field condition, and immediate reaction by generating a respective control signal for a product, which was identified to match the identified weed in this example. Treatment with the first product thus is rather a broadcast application to apply a blanket treatment targeting all weeds, where the treatment with the second product rather constitutes a spot spray application to either increase the dose of the first product or to apply a selected second product to targeted weeds. It should be noted that first and second product here also includes a first combination of products and a second combination of products, which combinations may be composed upon identification of a particular field condition. The relation of the field condition and the composition of the respective product may be laid down in a look-up table or a data model or an algorithm.

According to an embodiment, upon providing the generated control signal for controlling the respective spray nozzle or spray nozzle group for application of the second product in a particular sub-area, a control signal or generation of a control signal for controlling that respective spray nozzle or spray nozzle group for application of the first product in that particular sub-area is suppressed.

Thus, it can be avoided that a first product, from which it is assumed that it has not the desired effect for a critical weed, is wasted while the second product is applied to said weed.

According to an embodiment, a method is provided for controlling a smart spraying device, the method comprises generating a control signal as described above and controlling a respective nozzle of the smart spraying device based on the respective provided control signal.

According to an embodiment, there is provided a spraying device for carrying out a field treatment process, the smart spraying device comprises one or more individually controllable spray nozzle(s) or groups of spray nozzles, a receiving section for receiving control signals for the one or more individually controllable spray nozzle(s) or groups of spray nozzles provided by the above described method, and an actor device for activating selectively the one or more individually controllable spray nozzle(s) or groups of spray nozzles based on the provided control signals.

According to an embodiment there is described a system for a smart spraying process, the system comprises a computing capacity being adapted for carrying out the method above described, and a smart spraying device as described above, wherein the receiving section and the computing capacity are communicatively connected to each other to communicate control signals. According to an embodiment, the computing capacity is a distributed computing capacity, in particular a cloud and/or server based computing capacity.

According to an embodiment, a computer program product is provided being adapted for carrying out any of the methods above described.

According to an embodiment, a computer storage is provided having stored there on the computer program product above described.

It should be noted that the above describe methods in particular can be realized as a computer implemented method.

### Definitions

Area to be treated is the field section with the plantation thereon which underlies the treatment of a weed, a pest or disease by a product or agent. A sub-area is a part of the area which may be allocated to a particular treatment which differs from a treatment of other sub-areas at the same time. A treatment device may be designed so as to treat a particular sub-area or a number of sub-areas differently from other sub-areas at the same time. The treatment device may have a number of treating sections for different sub-areas and may have also sensors and/or detectors for sensing or detecting the respective sub-area for a vegetative indicator.

Vegetative indicator is an indicator indicating a vegetative condition of a plantation. A vegetative indicator may include one or more parameter(s), e.g., type or species parameter and quantity parameter(s). A vegetative indicator may include indicators with respect to different aspects. These may be a disease (disease indicator), a weed population (weed indicator), a pest population (pest indicator) or a planting growing condition (plant indicator or crop indicator) or the like. A plant indicator, disease indicator, a weed indicator or a pest indicator may be related to type or species of a plant (including crop), a disease, a weed and pests, respectively. A plant indicator, a crop indicator, a disease indicator, a weed indicator or a pest indicator, may also be related to a quantitative value such as a density, a number of plants, such as crops or weeds, number of insects, pests etc., development status of a disease, insects, pests etc. A product to be applied to an area or sub-area may be selected based on the type or species parameter. A dose rate may be derived from a type or species parameter and from a quantitative parameter. A vegetative indicator may include a quantitative parameter specifying a condition per sub-area, wherein dose rate may be derived from quantitative parameter. The vegetative indicator includes information on the plantation condition, which may be subject of an analysis so as to conclude a particular treatment with respect to e.g., application of an agent or a product. The vegetative indicator may be determined by providing the dataset, e.g., the image, to a data driven model segmenting one or more vegetative object(s), such as insect(s) or weed(s), and classifying detected object(s) according to vegetative specie(s) and/or vegetative type(s) based on such segmentation. The vegetative indicator may be determined by providing the dataset, e.g. the image, to a data driven model generating metadata comprising a region indicator signifying an dataset, e.g. the image, location of one or more vegetative object(s) in the obtained dataset, e.g. the image, and providing the vegetative indicator associated with the dataset, e.g. the image, wherein the data driven model is configured to have been trained with a training dataset comprising multiple sets of examples, each set of examples comprising an example dataset, e.g. image, of one or more vegetative object(s) in an example area and associated example metadata comprising a region indicator signifying an dataset, e.g. image, location of one or more vegetative object(s) in the example dataset, e.g. the image, and an example vegetative indicator associated with the dataset, e.g. the image.

Such analysis may be conducted for insects or weeds as vegetative objects relating to insect or weed indicator, respectively. The data driven model may be embedded in the treatment device. Such models may be stored in a cloud-based system optionally associated with area specific tags. Once a farmer subscribes to the service providing the location of the field in question the trained data-driven model suitable or associated with such location may be downloaded to the treatment device. Such down-/upload may occur once at service registration or regularly when updates of the trained model are available.

This way download traffic can be reduced, and the most recent model can be provided to be readily available on the agricultural area. In case of a vegetative indicator a dynamic set of thresholds relating to the vegetative indicator may be provided to the control system. In the case of any other indicator the basic threshold for triggering application of the treatment product relating to a basic parameter may be provided to the control system, wherein the dataset, e.g. the image, may be analyzed to determine the basic parameter, and wherein the control signal may be provided to control the treatment device based on the determined basic parameter and the basic threshold. In one embodiment, the basic parameter relates to a percentage of plant coverage in the area of interest, in particular a weed coverage and/or a crop coverage. The vegetative indicator may be a crop indicator relating to crop number value and/or crop size value. The plant indicator also may be a weed indicator relating to weed number value and/or weed size value. Based on the weed size value a basic or dynamic application rate to be applied to the agricultural area may be determined and a corresponding control signal may be generated to control the treatment device based on the determined application rate. The vegetative indicator may be a relative indicator relating to a plant density or a ratio between weed coverage and crop coverage. In particular crop density may be used as the plant indicator to control plant growth regulator and/or fungicide application to the agricultural area. Plant metadata associated with the agricultural area to be treated may be provided to the control system, and the dynamic adjustment of threshold(s) is activated based on plant metadata. Such metadata may include area specific plant information, such as crop growth stages or weed spectra from historical data, or an area specific activation code signifying that the agricultural field to be treated is registered with a service for dynamic threshold adjustment. Determining the vegetative indicator is performed by use of a data driven model, wherein the data driven model is used to analyze the dataset, e.g., the image, for determining the plant indicator.

The data-driven model may determine the plant indicator based on segmentation or attention mechanisms. The vegetation indicator may be determined by providing the dataset, e.g. the image, to a data driven model segmenting one or more plant(s) and providing the vegetation index based on such segmentation. The vegetation indicator may be determined by providing the dataset, e.g. the image, to a data driven model generating metadata comprising a region indicator signifying a dataset, e.g. an image, location of a crop in the obtained dataset, e.g. image, and providing the crop indicator associated with the dataset, e.g. the image, wherein the data driven model is configured to have been trained with a training dataset comprising multiple sets of examples, each set of examples comprising an example dataset, e.g. image, of one or more crops in an example area and associated example metadata comprising a region indicator signifying an dataset, e.g.

image, location of a plant in the example dataset, e.g. image, and an example crop indicator associated with the dataset, e.g. the image.

Real time field data are data which are received during the processing and application and immediately considered after collection without delay. Field data may include a vegetative indicator and the vegetative indicator may be derived from real time field data collected during treatment. With respect to a process of smart spraying, real time field data are data which are collected on the filed during the smart spray process and immediately fed to the system to be considered for the smart spray process. When considering real time image data, image data can be obtained from monitoring or imaging devices on the sprayer device to be controlled and fed to the process of spraying under way. Field data may be associated with a field condition and a vegetative indicator may be derived from image data collected during treatment of the field. With this respect, data is sensed, collected, analyzed and a treatment is conducted in real time based on analysis. Notwithstanding, a detector for real time data collection may have a physical distance from the treatment mechanism, e.g., nozzle or nozzle group, to obtain a delay in processing. Based on these real time field data location specific dose rates may be determined for respective sub-areas to be treated per nozzle or nozzle group.

Variable application map data are considered to be data which are, other than real time field data, associated with the field condition already before the process of smart spraying and include field data which may be collected prior to the treatment with a product. Field data in a variable application map may include a vegetative indicator. A vegetative indicator for a variable application map may be derived from remote sensing data such as satellite data including NDVI or LAI. From such field data predetermined variable application map may be determined which may include location specific dose rates for different sub-areas to be treated per nozzle or nozzle group. Such variable application map may be provided to a smart sprayer and control signal may be generated. As an alternative, a control signal may be generated in remote processing system such as the cloud and a determined control signal may be provided in location-specific manner on demand to the smart sprayer.

Product or Agent is what is applied to the plantation. A product may be, e.g., a herbicide, pesticide of fungicide, or a nutrition or the like. The concentration of the product may be subject of legal requirements and provisions. The concentration of a product may be achieved by mixing the agent with a diluent, e.g., water. The reduced concentration which is achieved by a diluent can be considered as the maximum concentration which is allowable and upon permanent application corresponds to the maximal possible application rate.

Dose rate is the rate with which a product is intended to be applied to a plantation. The dose rate is the amount of product per area. The dose rate is often defined by a volume of active ingredient per area, e.g., in the unit liter/acre. If a reference value is given for e.g., a maximum dose rate, the intended dose rate can also defined as a percentage thereof. In case a boom width of sprayer is known, upon constant spraying, an application rate directly relates to ground speed. The dose rate can be modified by modification of the basis concentration, by modification of the opening grade of the nozzle and/or the opening duration of the nozzle.

Actual Application rate is the rate with which a product is actually applied to a plantation. With a good working control the actual application rate is equal or near the dose rate. The actual application rate is similar defined as the dose rate, e.g., by a volume per area, e.g., in the unit liter/acre. Actual application rate may deviate from the dose rate in case the calculation of the dose rate did not consider a relevant parameter in the field, e.g., if for dose rate calculation variable ground speed is not considered, actual activation rate may deviate from dose rat upon curve driving or variable speed.

Actor device of a group of spray nozzles serves for activation of one or more nozzles. An actor device may include a separate actor for each nozzle or for a number of nozzles. A group of nozzles may have one or more nozzles. If more than one agent/product is to be applied, the same nozzles may be used for the application of different agents. However, also separate nozzles within one group of nozzles may be used for application of different agents. For the application of different agents, combined nozzles may be used, which include a single nozzle geometry but different feeding lines for different agents and valves for controlling the feeding of an agent or a mixture of agents to the nozzle geometry. Nozzles of a group of nozzles may be arranged adjacent to each other on a sprayer boom.

Crop is the cultivated plant onto which the harvesting is focused. Crop may be corn, soybean, sugar beet, cereals etc., but is not limited thereto.

Weed is the plant which is not desired beneath the crop and which may be treated with a herbicide. This may also include volunteer crops which remained from the previous season, which may be different from that of the present season.

Predetermined weed is a particular weed type or weed species which may be identified to require a particular treatment which is e.g., more intensive than the treatment of other weed types or weed species. The predetermined weed or weed type/species may be considered as a critical weed. Critical weed species/types are considered as those weeds that have a high negative impact on yield and food safety, or they belong to the increasing number of herbicide resistant weeds, so that a detection of such critical weed may be of particular interest. A critical weed may be subject to a particular detection, which allows an earlier detection and treatment in an earlier growing stage of the critical weed. A critical weed may also require application of a particular product, which is more efficient for that critical weed than for other weeds. Such products often are more expensive and/or may have other negative side effects, which can be avoided if such products are applied only in spots upon detection of the critical weed.

Plantation is all living biomass including crop and weed.

Pulse Width Modulation PWM is a process, where a variable controlling of a device is achieved by activating the device for a particular time, denoted as duty cycle, during a clock cycle, also denoted as basic cycle. For PWM a duration of pulse width is determined in relation to a dose rate. The basic cycle often is of a constant duration and the duration of the duty cycle defines the ratio of the activation time during a time period. In case a particular amount of a product is to be applied, e.g., by a nozzle, this amount of product is represented by the ratio of the duration of the duty cycle and the duration of the base cycle. Instead of permanently activating the nozzle partially, e.g., for 50% of an activation level, the nozzle is fully activated, but only for 50% of time, distributed over the base cycles, so that the ration of the duration of the duty cycle and the duration of the base cycle is 50%. This helps to avoid indefinite states of the nozzle having an indefinite spraying characteristic with, e.g., reduces spraying angle or not uniform distribution or dripping. Thus, liquid flow rate through each nozzle is managed via an intermittent, brief shutoff of the nozzle flow activated by an electric solenoid that replaces e.g., the spring-loaded check valve. Typical systems pulse at 10 Hz (the solenoid shuts off the nozzle 10 times per second), and the duration of the nozzle in the “on” position is called the duty cycle (DC) or pulse width. 100% DC means the nozzle is fully during the whole time on, e.g., with x kg/ha dose rate, and 20% DC means the solenoid is open only 20% of the time, resulting in the nozzle flowing at approximately 20% of its time capacity, e.g., with 20% *x kg/ha dose rate. The ability to control the duty cycle is referred to as pulse width modulation.

Pulse Width Frequency Modulation PWFM dos not only include the modulation of the duration of the duty cycle in a constant base cycle duration, but also the modulation of the base cycle. For PWFM a duration of the base cycle is determined, e.g., in relation to successive location-specific applications by an individual nozzle or a group of nozzles. The PWM has the character, that due to the activation for only a part of the base cycle, an activation gap occurs, which for some application may last too long. In this case, the duration of the gap may be reduced by reducing the base cycle, while maintaining the ratio of the duration of the duty cycle and the duration of the base cycle. If an actor has a reduced operating dynamic, e.g. may only operate at limited frequencies, the reduction of the base cycle may lead to a reduced resolution of the duty cycle. If an actor is capable of operating at 100 Hz, and the base cycle has 10 Hz (=100 ms), the duty cycle has a resolution of 10% of the base cycle (=10 ms). If reducing the base cycle to operate at 20 Hz (=50 ms), the resolution of that actor may be reduced to be only 20% of the base cycle, which is again 10 ms. This may be compensated by modulated adaption of the duty cycle from base cycle to base cycle.

Duty cycle is the period during which the spray nozzle is activated. This may correlate to the activation duration of an actor which activates the spray nozzle, considering the start and stop effects upon activation. For the modification of the dose rate the present invention suggests a nozzle activation at a full open stage during the activation period during which the nozzle is total open, instead of permanently partial opening of the nozzle. Thus, during total opening the nozzle has the defined nozzle spraying characteristic, whereas during partial opening of the nozzle spraying characteristic is not well defined, as different opening grades may lead to different and not reproducible spraying characteristics of the nozzle. Therefore, during the activation time the nozzle has a defined spraying characteristic, whereas the activation time may be periodically limited. This corresponds to a pulse width modulation (PWM) of a predetermined period as a clock. This allows a modification of the dose rate without having to modify the partial opening grade of the nozzle and without keeping the nozzle permanent on a semi activated and not defined opening state. Duration of the duty cycle is the absolute time duration of the duty cycle.

Base cycle or clock cycle is a period which is used as a basic measure which covers the activation period during the duty cycle. The predetermined period may be seen as a clock or clock pulse. The duration of the duty cycle may be at the beginning of the base cycle, at the end or somewhere in the middle of the base cycle. The maximum duration of the duty cycle is the full duration of the base cycle, which corresponds to a permanently activated state. The base cycle may be adapted in length so as to modify the clock during operation (PWFM). Modification of the base cycle is generally intended to be carried out on a long range, wherein a modification of the duty cycle is generally intended to be carried on a short range, at shortest modified in each successive base cycles. Duration of the base cycle is the absolute time duration of the base cycle.

Ratio between duration of the duty cycle and the duration of the base cycle is the ratio of the activation time compared to the total time. Sometimes this ratio is also denoted as duty cycle. A constant ratio between the duration of the duty cycle and the duration of the base cycle correlates to the total dose rate. The total dose rate is maximal if the duration of the duty cycle is as long as the duration of the base cycle, i.e., permanently activated, assumed that the concentration maintains un-changed and the nozzle is total open.

Geo-specific field or location-specific data are field data which are related to a particular geo-location, which may correspond with an area to be treated or a sub-area. Geo-specific filed data may include vegetative indicators relating to a particular geo location. Treatment based on geo-specific filed data allows a geo-specific treatment on demand. Geo-specific filed data may include information on the crop properties, like growth status and progress and crop type and species, soil condition, weed population, pest population, disease etc.

specific for the respective geo-location which may correspond to a particular area or sub area.

Ground speed of a nozzle is the speed of the respective nozzle relative to the ground or relative to the plantation. Ground speed of a group of nozzles is the speed of the respective group relative to the ground or relative to the plantation. In case the nozzles of a group of nozzles are arranged for example in a line and the group of nozzles moves along a curve, the ground speed for each nozzle of the group may be different, as the nozzles of the inner side of the curve have a lower ground speed compared to those nozzles at the outer side of the curve. In this case the ground speed of the group of nozzles may e.g. be the average of the speed of the single nozzles or the speed of the middle nozzle or a weighted average of the single speeds.

Application area of a nozzle is the area which is covered by a spray nozzle or a group of spray nozzles. The application area has a dimension in a moving direction of the spray nozzle which is usually the driving direction of the sprayer device, and a dimension traverse thereto. The application area may be rectangular and further may have a varying intensity distribution in the moving direction in order to compensate start and stop phases of the activation period. In the traverse dimension the intensity distribution may be uniform when adjacent areas of adjacent spray nozzles abut, and a varying, e.g., with an out-fading distribution in a traverse overlapping area, where adjacent areas of adjacent spray nozzles overlap, so that a resulting intensity distribution in the overlapping area can be kept substantially constant.

Overlap of application areas of an agent between applications of the agent in successive activation periods is the area which is covered by both, the present and the successive application area. The overlap may be given as a percentage of the entire area. An overlap of 50% means that 50% of the area have an overlap. A predetermined overlap may be zero, in case adjacent application areas in a moving direction of the spray nozzle abut but do not overlap. A predetermined overlap may be negative, in case adjacent application areas in a moving direction of the spray nozzle have a gap without application. The negative overlap corresponds to the width of the gap. An overlap of minus (−) 50% means that the gap area is 50% of the entire area.

Threshold(s) are level or ranges depending on which particular decisions are made upon carrying out the invention. Thresholds may be adjusted. A threshold may be determined to be directly or indirectly related to an indicator parameter. Thresholds may be geo-location specific, so that decision for a treatment decision may be based on geo-specific field data obtained in e.g., real-time while the treatment device (smart sprayer) travels through the agricultural area applying the treatment product. The vegetative indicator may be associated with a threshold related to an indicator parameter. The threshold may be understood as a value, the reaching, falling below and/or exceeding of which changes an operation mode of the method and thus the treatment device and as such the situation and location specific treatment conducted on the agricultural area. The threshold may be understood as a binary value flagging a condition that determines the decision logic of the method and thus the operation mode of the treatment device and as such the situation and location specific treatment conducted on the agricultural area. The threshold also may be defined as a transition range, one end thereof defining a minimum activation and the other end defining a maximum activation, with a transit characteristic in between defining an allocation of the threshold and the corresponding activation level. The threshold may determine based on the determined vegetative indicator relating to the real-time conditions on the agricultural area, which operation mode the treatment device (mart sprayer device) or individual treatment component(s) (nozzle or nozzle groups) is/are going to be controlled in. In one embodiment the threshold may trigger an on/off decision for individual treatment components based on the threshold, the vegetative indicator derived from the obtained dataset, e.g., the image. Further examples of operation modes may comprise one or more flat rate or broadcast operations in which the same quantity of a treatment product is applied over a defined total area across multiple or all treatment components, a variable rate application (VRA) operation in which, e.g. based on a map, a first quantity of a treatment product is applied over multiple sub-areas, such as a first sub-area, a second sub-area, etc., and/or or a simple activation or deactivation of the individual treatment components is performed on the spot e.g. for spot spraying. Any such operation mode is performed by providing a corresponding control parameter set with respective control signal(s) for e.g., individual treatment components. Further, different operation modes may correspond to different dose rates of the treatment product for one or more of the treatment component(s). A set of thresholds may include one or more thresholds. It may be provided by a cloud-based computing system or by a treatment device-based system as embedded software or by a combination thereof. The set of thresholds may be received prior to treatment on the agricultural area by the treatment device. In such way situation specific control of the treatment device can be accelerated and the processing time can be reduced to a minimum such that the situation specific treatment can be applied while the treatment device traverses through the agricultural area with minimum loss in travelling speed. Thus, decisions can be made on the fly while the treatment device travels, e.g., traverses, through the agricultural area, e.g., field, and captures location specific data, such as images, of the agricultural area locations to be treated.

Product identification is the identification of a suitable product for the treatment based on vegetative indicators. Upon detection of a particular parameter of the vegetative indicator(s), a decision logic may determine the most suitable product or product combination. The product identification (product ID) may be carried out by a look-up table having included a one or more dimensional allocation of parameters and parameter values, e.g. a weed type/species, a weed density etc., and a corresponding product, product combination or product ID. The identification can also be carried our based on an AI, which includes a self learning algorithm, which allows also identification of a product or product combination for a parameter, which was not detected before.

### BRIEF DESCRIPTION OF THE FIGURES

These and other aspects of the invention will be apparent from and elucidated further with reference to the embodiments described by way of examples in the following description and with reference to the accompanying drawings, in which

FIG. 1 illustrates smart farming machinery as part of a distributed computing environment;

FIG. 2 illustrates an exemplary embodiment of a sprayer device;

FIG. 3 illustrates a more detailed exemplary embodiment of the sprayer device;

FIG. 4: illustrates the method for generating and providing a control signal for a spray nozzle according to an exemplary embodiment;

FIG. 5: illustrates the method for generating and providing a control signal for a spray nozzle according to another exemplary embodiment;

FIG. 6: illustrates the method for generating and providing a control signal for a spray nozzle according to another exemplary embodiment;

FIG. 7: illustrates the method for generating and providing a control signal for a spray nozzle according to another exemplary embodiment;

FIG. 8: illustrates the method for generating and providing a control signal for a spray nozzle according to another exemplary embodiment;

FIG. 9: illustrates a relation between a dose rate and a corresponding response for different herbicides according to an exemplary embodiment;

FIG. 10: illustrates a relation between a dose rate and a corresponding response of different weeds/different weed sizes according to an exemplary embodiment;

FIG. 11: illustrates a spray pattern depending on the PWM pattern according to an exemplary embodiment;

FIG. 12: illustrates a PWM pattern for different duty cycles according to an exemplary embodiment;

FIG. 13: illustrates a PWM pattern of corresponding duty cycles but modified base cycle PWFM according to an exemplary embodiment;

FIG. 14: illustrates the effect of a modified base cycle PWFM according to an exemplary embodiment;

FIG. 15: illustrates a PWM pattern for different products according to an exemplary embodiment;

FIG. 16: illustrates a tractor with a sprayer device according to an exemplary embodiment; and

FIG. 17: illustrates a curve compensation with modification of the duty cycle of a PWM according to an exemplary embodiment.

### DETAILED DESCRIPTION OF EXEMPLARY EMBODIMENTS

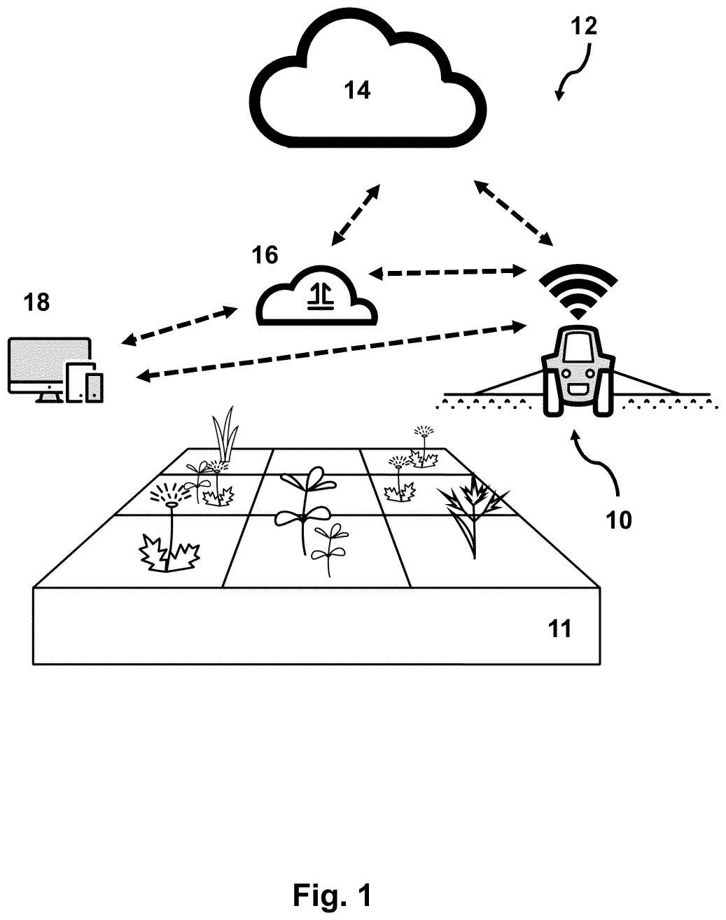

FIG. 1 illustrates smart farming machinery 10 as part of a distributed computing environment. The smart farming machinery 10 may be a smart sprayer and includes a connectivity system 12. The connectivity system 12 is configured to communicatively couple the smart farming machinery 10 to the distributed computing environment. It may be configured to provide data collected on the smart farming machinery 10 to one or more remote computing resources 14, 16, 18 of the distributed computing environment. One computing resource 14, 16, 18 may be a data management system 14 that may be configured to send data to the smart farming machinery 10 or to receive data from the smart farming machinery 10. For instance, as detected maps or as applied maps comprising data recorded during application on the agricultural area 11 may be sent from the smart farming machinery 10 to the data management system 14. A further computing resource 14, 16, 18 may be a field management system 16 that may be configured to provide a control protocol, an activation code or a decision logic to the smart farming machinery 10 or to receive data from the smart farming machinery 10. Such data may also be received through the data management system 14. Yet a further computing resource 14, 16, 18 may be a client computer 18 that may be configured to receive client data from the field management system 16 and/or the smart farming machinery 10. Such client data includes for instance application schedule to be conducted on certain fields with the smart farming machinery 10 or field analysis data to provide insights into the health state of certain fields.

In particular when data is recorded by the farming machinery 10, such data may be distributed to every computing resource 14, 16, 18 of the distributed computing environment. The farming machinery may for instance include a spraying device 20 including a monitoring system 36 for monitoring spray application. In one example the monitoring of the spray nozzles 28 may be done via the least number of sensors 34, 38 built into the fluidic system. Such sensors 34, 38 are preferably placed in the fluidic line of a subset of nozzles 28 or all nozzles 28. Together with the activation signal for controlling valves of the nozzles and/or the tank(s), the system has sufficient information to determine e.g., 1) deviations of the measured fluid property from the expected fluid property, and/or 2) a spray nozzle specific fluid property, and/or 3) a fluid property as measured by the sensor in the fluidic line, and/or 4) a spray nozzle position causing deviations.

Any such data may be recorded during operation and transferred to e.g. the data management computing resource in real-time during each operation run or after operation run. Based on such data any misapplication on the agricultural area can be analyzed after operation.

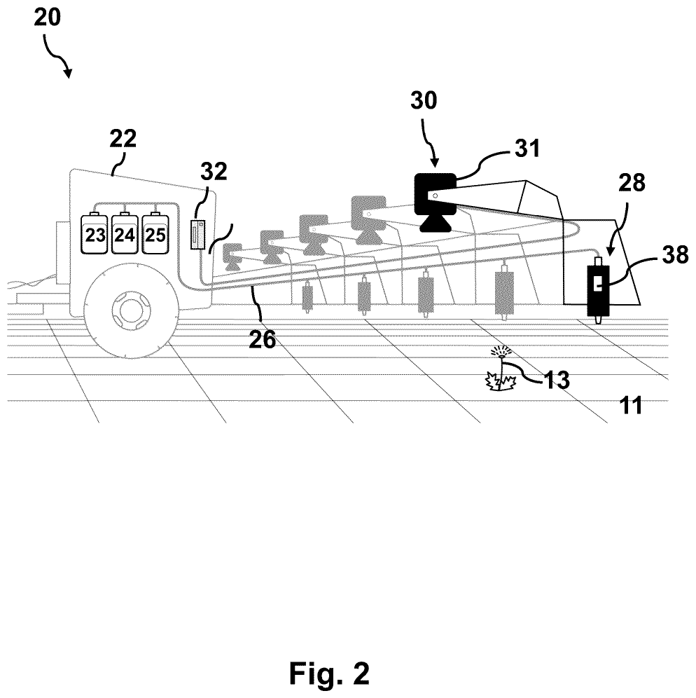

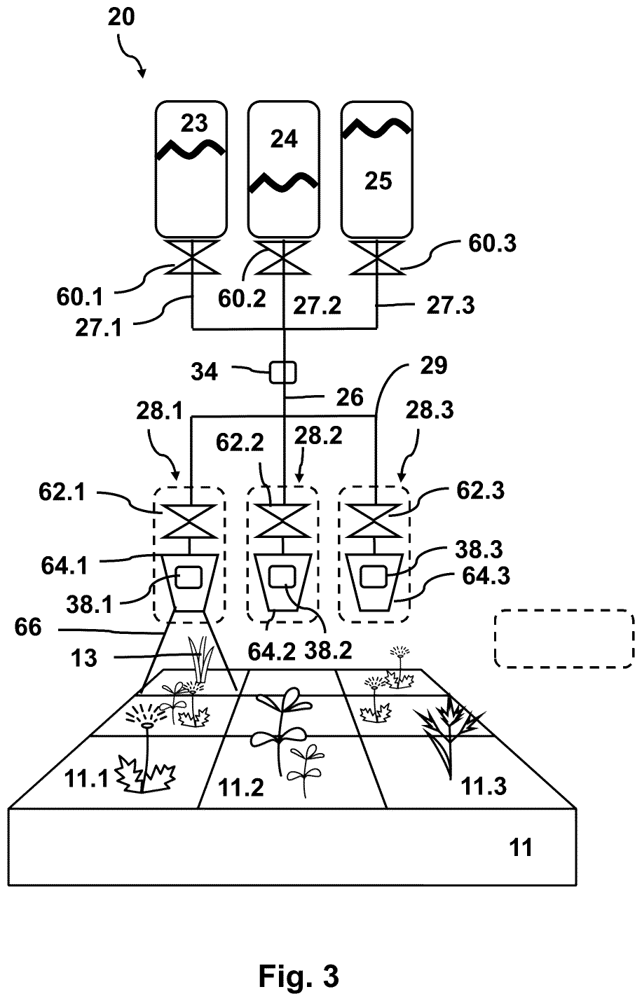

FIG. 2 shows an example of a sprayer device 20, and FIG. 3 shows a more detailed example of the sprayer device 20. For the sake of clarity, FIGS. 2 and 3 are principle sketches, where the core elements are illustrated. In particular, the fluidic set up shown is a principle sketch and may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also different fluidic set ups and mixing arrangements may be chosen. The invention disclosed here is, however, applicable to all fluidic setups, which have at least one common fluidic line serving a subset or group of spray nozzles or all spray nozzles with one or more fluids.

The smart farming machinery 10 of FIGS. 2 and 3 comprises a tractor (not shown) with a sprayer device 20 for applying a product such as a herbicide, a fungicide or an insecticide on the agricultural area 11. The sprayer device 20 may be releasable attached or directly mounted to the tractor or a self-driving device. The sprayer device 20 comprises a boom with a plurality of spray nozzles or plurality of groups of spray nozzles 28 arranged along the boom of the sprayer device 20. The spray nozzles/group of spray nozzles 28 may be arranged fixed or movable along the boom in regular or irregular intervals. Each spray nozzle 28 may arranged together with a controllable valve 62 controlled by an actor device to regulate fluid release from the spray nozzles 28 to the agricultural area 11.

One or more tank(s) 23, 24, 25 are in fluid communication with the nozzles 28, 28.1, 28.2, 28.3 through common fluidic line 26, which distributes the mixture as released from the tanks 23, 24, 25 to the spray nozzles 28, 28.1, 28.2, 28.3. Each tank 23, 24, 25 holds one or more agents or ingredient(s) or products 23, 24, 25 of the fluid mixture to be released on the agricultural area 11. This may include chemically active or inactive ingredients like a herbicide mixture, individual ingredients of a herbicide mixture, a selective herbicide for specific weeds, a fungicide, a fungicide mixture, ingredients of a fungicide mixture, ingredients of a plant growth regulator mixture, a plant growth regulator, water, oil, or any other formulation agent. Each tank 23, 24, 26 may further comprise a controllable valve 60.1, 60.2, 60.3 to regulate fluid release from the tank 23, 24, 25 to the fluid lines 27.1, 27.2, 27.3, 26, 29. Such arrangement allows controlling the mixture released to the agricultural area 11 in a targeted manner depending on the conditions sensed on the agricultural area 11.

For sensing the sprayer device 20 includes a detection system 30 with multiple detection components 31 arranged along the boom. The detection components 31 may be arranged fixed or movable along the boom in regular or irregular intervals. The detection components 31 are configured to sense one or more conditions of the agricultural area. The detection components 31 may be an optical detection component 31 providing an image of the field.

Suitable optical detection components 31 are multispectral cameras, stereo cameras, IR cameras, CCD cameras, hyperspectral cameras, ultrasonic or LIDAR (light detection and ranging system) cameras. Alternatively, or additionally, the detection components 31 may include further sensors to measure humidity, light, temperature, wind or any other suitable condition on the agricultural area 11.

The detection components 31 are arranged e.g., perpendicular to the movement direction of the sprayer device 20 and in front of the nozzles 28 (seen from drive direction). In the embodiment shown in FIG. 2, the detection components 31 are optical detection components and each detection component 31 is associated with a single nozzle 28 such that the field of view comprises or at least overlaps with the spray profile of the respective nozzle 28 on the field once the nozzle reach the respective position. In other arrangements, each detection component 31 may be associated with more than one nozzle 28 or more than one detection component 31 may be associated with each nozzle 28.

The detection components 31, the tank valves 60.1, 60.2, 60.3 and the nozzle valves 62.1, 62.2, 62.3 are communicatively coupled to a control system 32. In the embodiment shown in FIG. 2, the control system 32 is located in the main sprayer housing 22 and wired to the respective components. In another embodiment detection components 31, the tank valves 60.1, 60.2, 60.3 or the nozzle valves 62.1, 62.2, 62.3 may be wirelessly connected to the control system 32. In yet another embodiment more than one control system 32 may be distributed in the sprayer housing 22 or the tractor and communicatively coupled to detection components 31, the tank valves 60.1, 60.2, 60.3 or the nozzle valves 62.1, 62.2, 62.3.

The control system 32 is configured to control and/or monitor the detection components 31, the tank valves 60.1, 60.2, 60.3 or the nozzle valves 62.1, 62.2, 62.3 following a control protocol. In this respect the control system 32 may comprise multiple modules. One module for instance controls the detection components 31 to collect data such as an image of the agricultural area 11. A further module analyses the collected data such as the image to derive parameters for the tank or nozzle valve control. Yet further module(s) control(s) the tank valves 60.1, 60.2, 60.3 and/or nozzle valves 62.1, 62.2, 62.3 based on such derived parameters.

In addition to the control system 32 the sprayer device 20 comprises a monitoring unit 36, which may be any processing device with respective interfaces suitable to receive data measured by sensors 34, 38 or from the control system 32. In particular, the monitoring unit is configured to receive data from sensor 34 arranged to measure a fluid property present in common fluidic line 26. As shown in FIG. 3, the common fluidic line 26 serves multiple spray nozzles 28.1, 28.2, 28.3 with a fluid mixture from tanks 23, 24, 25. To control the amount of fluid released from the tank valves 60.1, 60.2, 60.3 are associated with each tank 23, 24, 25 respectively. Depending on the conditions sensed on the agricultural area 11, the control system 32 determines a composition of the chemical agent to be released and provides the activation signal to the tank valves 60.1, 60.2, 60.3 to provide respective amount to the fluidic lines 27.1, 27.2, 27.3., respectively. In the example of FIG. 3 the fluid streams are mixed in common fluidic line 26 where the mixture fed into distribution lines 29 to the individual spray nozzles 28.1, 28.2, 28.3. Each spray nozzle 28.1, 28.2, 28.3 includes nozzle valves 62.1, 63.2, 62.3, which is triggered for spraying depending on the activation signal provided by the control system 32. Depending on the desired application rate provided by the activation signal the application nozzles 64.1, 64.2, 64.3 are controlled to spray the respective amount per activated spray nozzle 28.1, 28.2, 28.3 onto the agricultural area 11.

To monitor the operation of individual spray nozzles 28.1, 28.2, 28.3 sensors monitoring fluid properties are used. The fluid property sensed in the common fluidic line may be a fluid flow as measured by sensor 34. Further sensors may measure other fluid properties such as composition of the applied fluid. Such sensors 38.1, 38.2, 38.3 may be placed at each spray nozzle 28.1, 28.2, 28.3 as shown in FIG. 3 or also in the common fluidic line 26 to monitor the composition of the mixture flowing thereto.

One focus is the generation of a control signal based on the connection between a vegetative indicator, in particular weed indicator (real-time or not) and a nozzle specific PWM (Pulse Width Modulation, open and closed cycles in a fixed clock cycle) or a nozzle specific PWFM (Pulse Width and Frequency Modulation, open and closed cycles in a modulated/varied clock cycle) to adjust dose rate. A critical weed can be identified in a weed indicator for specific location based on either a real time analysis or an analysis of earlier dates. For earlier dates, the analysis can also be carried our earlier, and then provided at the field device for carrying out e generation of the control signal or directly controlling the field device, here a sprayer device. For a critical weed, a stricter threshold for on/off decision may be taken (stricter means more sensitivity of the system to weed occurrence, e.g., weed density is measured and the on-decision for PWM or PWFM is taken for lower density levels. Upon critical weed detection the duty cycle is determined and applied if critical weed present, wherein the duration of the duty cycle is adapted according to the critical weed density. Accordingly, the dose rate is adjusted upon identification of a critical weed by the system according to weed occurrence, e.g., weed density is measured and a dose rate is increased through PWM also for lower sized critical weed. For a critical weed, the threshold for spraying is set earlier so as to have “more sensitivity to critical weed of lower density”. The dose rate for spraying is adapted so as to have “more sensitivity to size of weeds. A critical weed at earlier growth stage may for example need less dose rate but more sensitive threshold for detecting the critical weed at such early growing stage. If it is detected that a critical weed has a later growth stage, it may need a higher dose rate. For this purpose, the PWM or PWFM algorithm may have a continuous adaption of the duty cycles based on field data or may have pre-set levels for the duty cycles. The duty cycle upon detection of the weed is dependent on e.g., the size of weed and the growth stage thereof. The duty cycle of the PWM may also be dependent on regional regulatory requirements to not overdose (upper limit). The duty cycle of the PWM may also be dependent on speed and turn correction, because when making a turn while spraying, different nozzles move at different speeds, i.e., the outside turn is along a longer path, than the inside turn. In order to spray consistently at the same rate, faster moving nozzles need to spray more, and slower moving nozzles need to spray less, which may be reflected by the duration of the duty cycle.

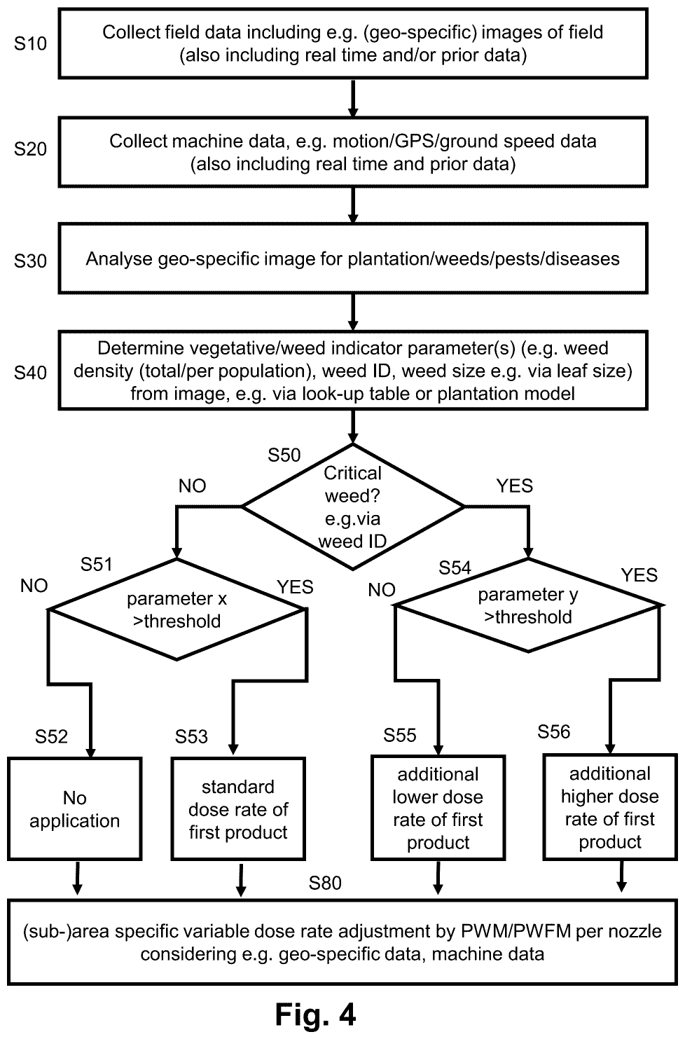

FIG. 4 illustrates the method for generating and providing a control signal for a spray nozzle according to an exemplary embodiment. In step S10 field data including e.g. (geo-specific) images of field are collected. This may include real time and/or prior collected data. Real time data may be collected from sensing devices like cameras mounted in association with the spray nozzles. Prior collected data may be data collected from earlier rides on the field, from satellite images, from unmanned flight objects UFO like drone images. In Step S20 machine data may be collected, e.g., motion date from wheel and steering sensors, from a GPS or from a ground speed sensor. These data may be real time or prior collected data, e.g., from earlier rides in the same field where all machine and motion data were collected so that a motion of the machine is copied during the next treatment. While the machine motion is copied the controlling of the sprayer device may be adapted in real time based on real time collected data on the field. The real time collected data may e.g., include a geo-specific image including geo-location specific information on the vegetation. In step S30 the geo-specific image is analyzed for the plantation, the weeds, the pests and/or diseases. Based on this image analysis in step S40 a vegetative indicator, in particular the weed indicator is determined and parameter(s) are identified and quantified, e.g., a total weed density, a population specific weed density, a weed type/species and weed ID, a weed size, e.g. via leaf size. The parameters and parameter values may be determined, e.g., via a look-up table or a plantation model. In step S50 it is identified whether a critical weed is present. This can be done e.g., by a spectral analysis of a real time image taken. If no presence of a critical weed is identified (but only of less critical weed), it is determined in step S51 whether the level of less critical weed is above a certain threshold. If not, it is decided in step S52 that no application occurs. It should be noted that instead also a low level of application can be chosen, as FIG. 4 is only exemplary. If the level is above a certain threshold, a standard dose rate of a first product is applied in step S53. If in step S50 it is identified that a critical weed is present, it is determined in step S54 whether the level of critical weed is above a certain threshold. If not, it is decided in step S55 that a lower additional dose rate of the first product is applied. If the level is above a certain threshold in step S54, a higher additional dose rate of the first product is applied in step S56. In step 80 a dose rate for an area or separately for each sub-area is adjusted by setting the respective duty cycle of the PWM, PWFM for each nozzle.

FIG. 5 illustrates the method for generating and providing a control signal for a spray nozzle according to another exemplary embodiment. The general structure of the process in FIG. 5 is similar to the process illustrated in FIG. 4, so that the respective description applies. FIG. 5 differs in the steps S50ff. In step S50 it is again identified whether a critical weed is present. If no presence of a critical weed is identified (but only of less critical weed), it is determined in step S51 whether the level of less critical weed is above a certain threshold. If not, it is decided in step S52 that no application occurs. Also, here it should be noted that instead also a low level of application can be chosen. If the level is above a certain threshold, a standard dose rate of a first product is applied in step S53. If in step S50 it is identified that a critical weed is present, it is determined in step S54 whether the level of critical weed is above a certain threshold. If not, it is decided in step S57 that a lower dose rate of a second product is applied. If the level is above a certain threshold in step S54, a higher dose rate of the second product is applied in step S58. In step 80 again, a dose rate for an area or separately for each sub-area is adjusted by setting the respective duty cycle of the PWM, PWFM for each nozzle. It should be noted that upon the identification of a critical weed in step S50, the step 51 and the following steps may be carried out in parallel or may be suppressed. A parallel application of a first product and a second product may be advised, if e.g., the first and second product have a synergetic effect, and one product amplifies the effect of the other product. A suppression of the application of the first product is advised, if e.g., upon application of the second product, the first product remains without effect.

The steps S50ff. in FIG. 4 and FIG. 5 can be modified and supplemented to include a more detailed decision tree where the product selection is based on a detected weed, a detected insect, and/or a disease type. Also, the dose rate may be adjusted along that decision tree based on a weed size, number and/or density, an insect number, size and/or density, and/or a disease size, density and/or a number of infected leaf as an indicator.

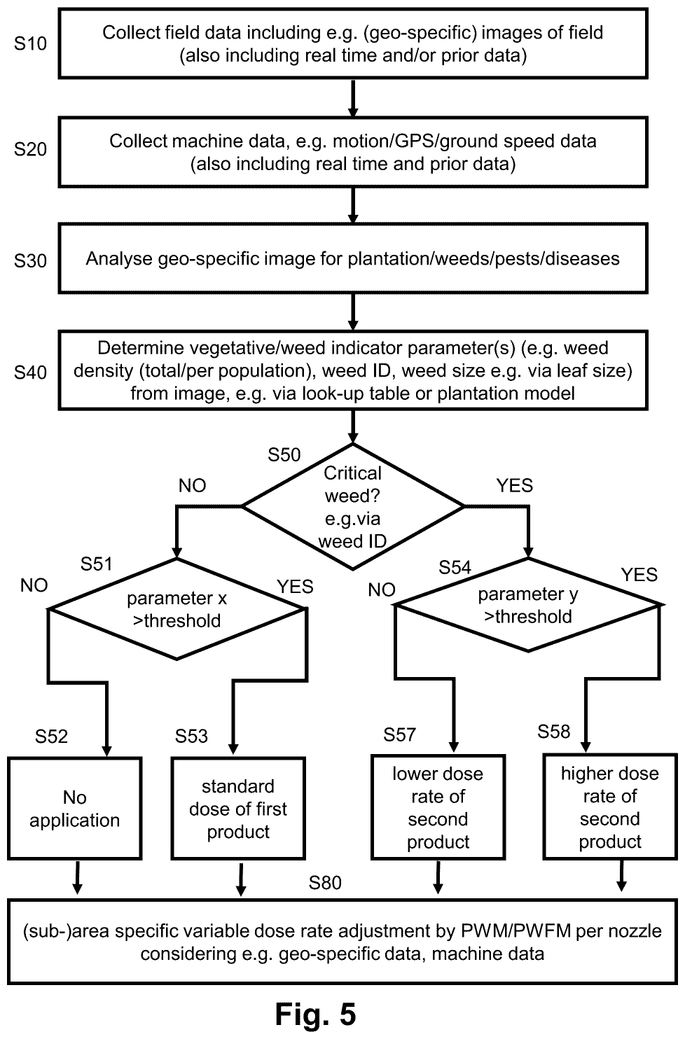

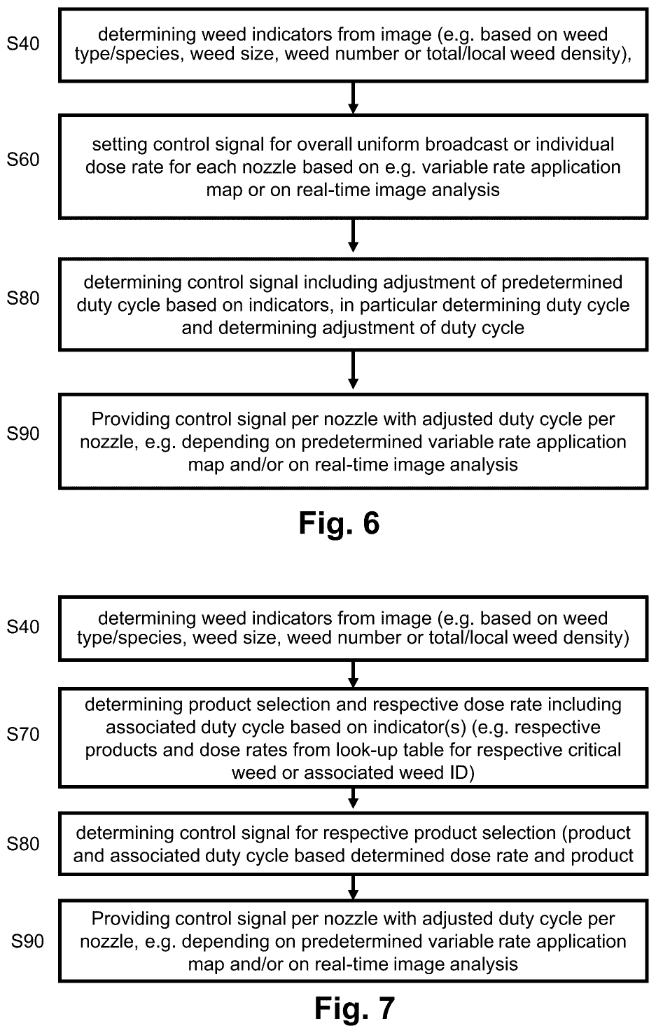

FIG. 6 illustrates the method for generating and providing a control signal for a spray nozzle according to another exemplary embodiment. According to an embodiment, a broadcast spray is applied with respective dose rates for broadcasting a spray process where all nozzles are set to a predetermined dose rate and are controlled accordingly. In step S40 weed indicators are determined from image field data. From image field data, a type, size, number or density of a weed can be determined. In step S60, control signals are set for overall uniform broadcast or individual dose rate for each nozzle based on e.g., variable rate application map or on real-time image analysis. Based thereon, in step S80, control signals are determined and set including adjustment of predetermined duty cycle based on indicators e.g., depending on weed indicator(s) representing e.g., a size, a number and/or a density of a weed, and a duty cycle is determined and adjusted. In step S90 a control signal per nozzle is provided with adjusted duty cycle per nozzle where applicable depending either on a predetermined variable rate application map or on real-time image analysis.

FIG. 7 illustrates the method for generating and providing a control signal for a spray nozzle according to another exemplary embodiment with multiple application lines for a smart sprayer, where more than one product may be available in tank system (hardware). in such case the software logic may include digital IDs for products and the logic may be as illustrated in FIG. 7. In step S40 weed indicators are determined from image field data, e.g., a type, a size, a number and/or a density. In step S70, a control signal is determined including product selection and an associated duty cycle based on indicator(s). When providing a plurality of different products, all available products may be represented in a look-up table or a respective algorithm. A particular product may be allocated to a list for critical weed (or associated weed ID) and another product may be allocated to rather non-critical weed (or associated weed ID). Each product may be selected depending on other parameters, like a size, a number, a density of the associated weed. A respective duty cycle may be determined for each product independently. In step 80, a control signal is determined for a respective product selection (product and associated duty cycle based determined dose rate and product). In step 90 a control signal is provided per nozzle location depending either on a predetermined variable rate application map or on a real-time image analysis.

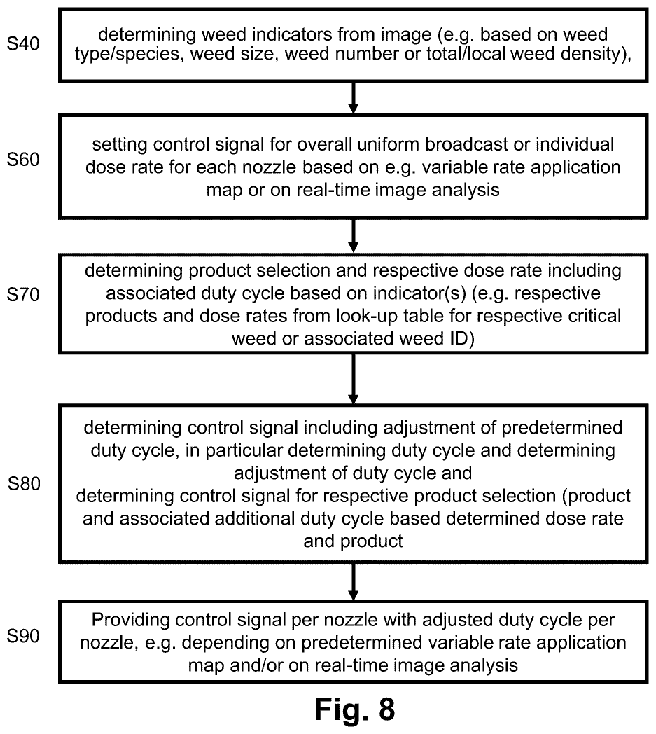

FIG. 8 illustrates the method for generating and providing a control signal for a spray nozzle according to another exemplary embodiment, where the aspects of FIG. 6 and the aspects of FIG. 7 are combined. A broadcast application is applied to apply a blanket treatment targeting for all weeds combined with a spot spray application to increase the dose to targeted weeds. For broadcast all nozzles are set to predetermined dose rate and are controlled accordingly for example all with a first product. Weed indicators are determined from image field data, e.g., a type, a size, a number and/or a density. In step S40 weed indicators are determined from image field data. From image field data, a type, size, number or density of a weed can be determined. In step S60, control signals are set for overall uniform broadcast or individual dose rate for each nozzle based on e.g., variable rate application map or on real-time image analysis. In step S70, a product is selected, a dose rate and an associated duty cycle based on indicator(s). When providing a plurality of different products, all available products may be represented in a look-up table or a respective algorithm. A particular product may be allocated to a list for critical weed (or associated weed ID) and another product may be allocated to rather non-critical weed (or associated weed ID). Each product may be selected depending on other parameters, like a size, a number, and/or a density of the associated weed. A respective duty cycle may be determined for each product independently. Based thereon, in step S80, control signals are determined and set including adjustment of predetermined duty cycle based on indicators e.g., depending on weed indicator(s) representing e.g., a size, a number and/or a density of a weed, and a duty cycle is determined and adjusted for each product separately. In step S90 a control signal per nozzle is provided with adjusted duty cycle per nozzle where applicable depending either on a predetermined variable rate application map or on real-time image analysis. Further, a control signal is determined including additional determination of a duty cycle for a second product depending on weed indicator(s) e.g., a size, a number, and/or a density. A control signal per nozzle for the first product and/or the second product is provided where applicable depending either on a predetermined variable rate application map or on a real-time image analysis. This includes two scenarios: Either switching between first and second product, i.e., suppressing application of first product upon application of second product, or applying first and second product. When both products are applied, the dose rate may be adjusted according to the combined application.

For FIGS. 4, 5, 6, 7, and 8 it should be noted that the corresponding step numbers have a similar focus but may deviate according to the purpose of illustration in the respective flow chart.

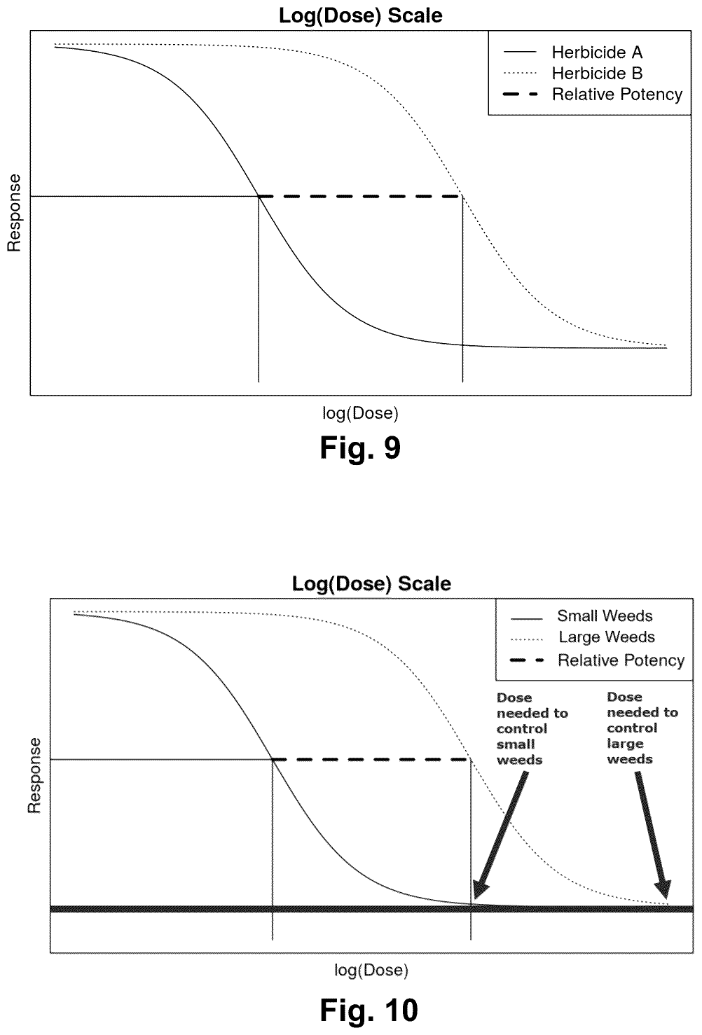

FIG. 9 illustrates a relation between a dose rate and a corresponding weed control response for different herbicides according to an exemplary embodiment. Herbicide A reduces the number of weeds of a particular type of weed at a lower dose compared to herbicide B. Herbicide A for weeds of a particular type therefore is more efficient than Herbicide B for the same type of weed, as a lower dose is required for achieving the same effect. However, herbicide A may be more expensive or may have a stronger regulatory limitation, so that the application of herbicide A should be minimized to an optimum.

FIG. 10 illustrates a relation between a dose rate and a corresponding response of different weeds/different weed sizes according to an exemplary embodiment. A particular herbicide reduces the number of small weeds at a lower dose than a number of large weeds. The herbicide therefore is more efficient for small sized weeds than for large size weeds. The dose rate for controlling large weed is therefore higher than the dose rate for controlling small weeds. This knowledge may be used to identify the suitable herbicide for a particular weed indicator, here the weed indicator of the weed size.

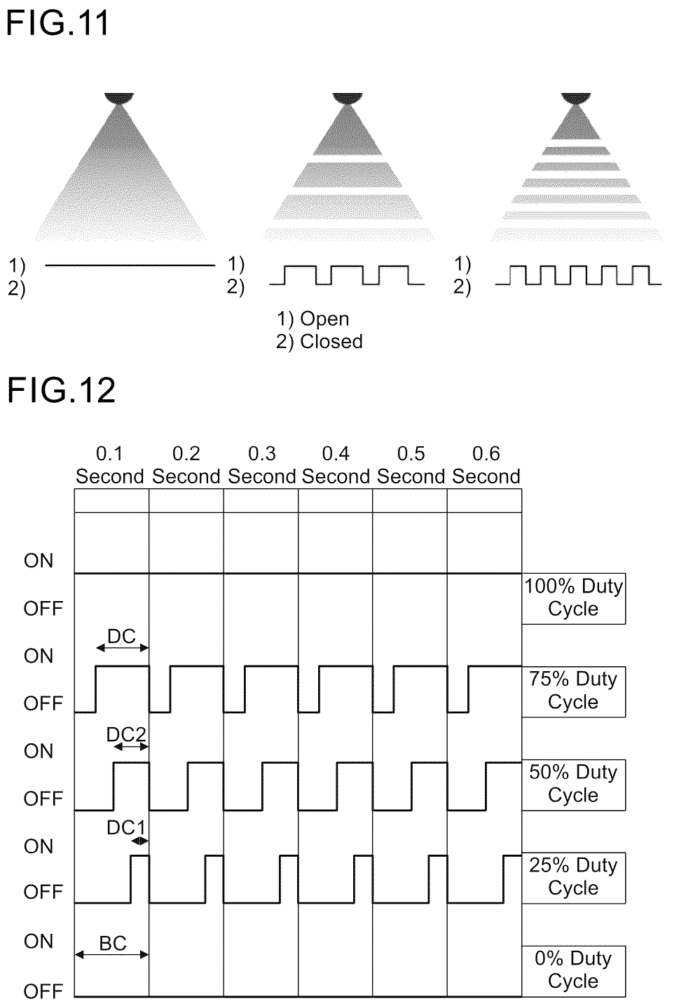

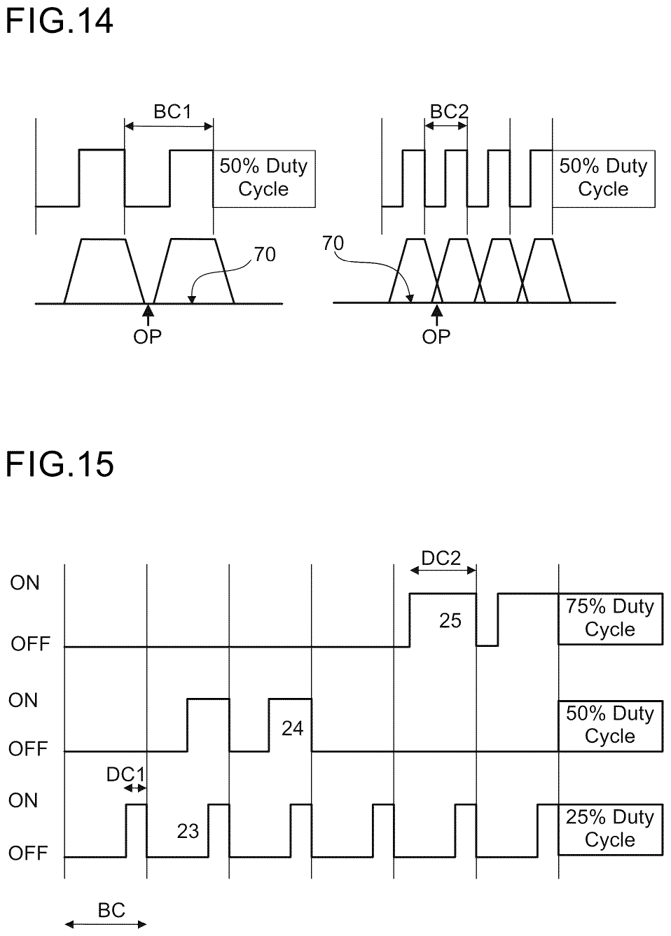

FIG. 11 illustrates a spray pattern depending on the PWM pattern according to an exemplary embodiment. If the nozzle is permanently open, i.e., the duty cycle is 100%, the spray pattern is uniform and homogeneous. In case the duty cycle is lower than 100%, the nozzle is closed for a particular time duration, so that stripes may occur, where no product is applied. Depending on the ratio of the opening time, i.e., the duty cycle, and the closed time, i.e. the base cycle minus the duty cycle, the stripes of application areas and the stripes of no application area may vary. As long as the gaps remain small enough, no problem occurs upon application, as illustrated in and described with respect to FIG. 14 in detail.

FIG. 12 illustrates a PWM pattern for different duty cycles according to an exemplary embodiment. Depending on the relative time of opening in a duty cycle DC during a base cycle BC, the dose rate changes. The illustrated embodiment shows that assumed the relative speed over ground is the same for all lines and the nozzle is fully open if “on”, the maximum dose rate is achieved at a permanently opening of the nozzle with a duty cycle of 100%, which leads to the maximum dose rate of 100%. If the duration of the opening is reduced to 75%, i.e., the duty cycle is 75%, also the dose rate reduced to be at only 75% of the maximum possible dose rate. If the duration of the opening is reduced to 50%, i.e., the duty cycle DC2 is 50%, also the dose rate reduced to be at only 50% of the maximum possible dose rate. If the duration of the opening is reduced to 25%, i.e., the duty cycle DC1 is 25%, also the dose rate reduced to be at only 25% of the maximum possible dose rate. Thus, the amount of product per area which corresponds to the dose rate, can be set to the intended dose rate.

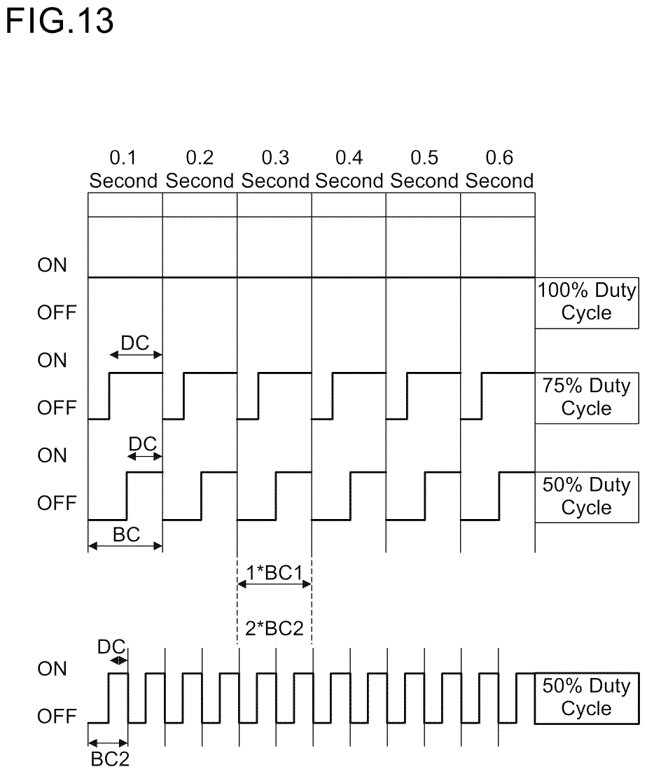

FIG. 13 illustrates a PWM pattern of corresponding duty cycles but modified base cycle PWFM according to an exemplary embodiment. There may be some cases where e.g., the ground speed is very high, so that the gap during which the nozzle is closed is too large, so that application gaps occur, where no application of a product applies. In such cases the dose rate should not be modified, but as an alternative it is possible to reduce the duration of the base cycle or clock cycle, as illustrated in the bottom PWFM diagram, while maintain the ration of the duration of the duty cycle and the base cycle. In FIG. 13, the upper three PWM diagrams correspond to those illustrated in FIG. 12. The 50% duty cycle diagram has the base cycle BC1 having a duration of 0.1 second (=100 ms). In this PWM pattern a gap of 0.05 seconds (=50 ms) occurs between two successive duty cycles DC. If this gap is too large, the duration of the base cycle may be reduced to be e.g., only 0.05 second (=50 ms), as illustrated tin in the most bottom PWM diagram. If applying a duty cycle of again 50%, the dose rate does not change, but the gap is reduced to only 0.025 seconds (=25 ms). Thus, the application gap is reduced. The effect of this measure is illustrated in detail in FIG. 14.

FIG. 14 illustrates the effect of a modified base cycle PWFM according to an exemplary embodiment. The left illustration shows a PWM pattern with a base cycle BC1 of 100 ms and a duty cycle of 50%. The gap between two successive duty cycle durations DC is 50 ms. If applying a product with a sprayer characteristic having steep flanges, it may happen, that there is a negative overlap, i.e., a gap between two adjacent application areas 70. Due to the flanges, the application areas are a little bit broader than the corresponding 50 ms gap, but a gap in form of a negative overlap OP may remain in the left illustration. If the base cycle is reduced to have a duration of the base cycle BC2 of only 50 ms, but the duty cycle remains as 50%, effectively the duration of the duty cycle reduces to 25 ms, and also the gap reduces to 25 ms, as illustrated on the right side of FIG. 14. When applying a product with the same sprayer characteristic, i.e., same steepness of the flanges, the application areas 70 reduce in width, but are closed to each other. As a consequence, both application areas 70 have a positive overlap OP, i.e., really overlap, and the gap is closed. It should be noted, that a nozzle has a maximum operation frequency, which is limited by its physical dimensions and properties. Reduction of the base cycle does not change the absolute operation frequency of the nozzle but leads to a reduced relative resolution within a base cycle.

FIG. 15 illustrates a PWM pattern for different products according to an exemplary embodiment. When applying a plurality of different products, i.e., operating with a plurality of product ID's, different products may be applied at different times and with different dose rates. The first product 23 here is applied with a duty cycle ratio of 25% but constantly over the time. This may correspond to the broadcast blanket applied for the entire area. Upon detection of e.g., a critical weed at a particular geo-location the control signal is generated to activate the nozzle (either the same nozzle fed by a plurality of products, or a separate nozzle for each product allocated to the same sub-area) for the second product (product ID) 24 with a duty cycle ratio of 50%. The selection of the second product (product ID) occurs due to e.g., the detection of a critical weed type or weed species (weed ID), whereas the selection of the duty cycle rate of 50% occurs due to the detected density or size of that critical weed type or species (weed ID). The same applies for the third product 25. Upon detection of another critical weed (weed ID) at another particular geo-location the control signal is generated to activate the nozzle (either the same nozzle fed by a plurality of products, or a separate nozzle for each product allocated to the same sub-area) for the third product (product ID) 25 with a duty cycle ratio of 75%. The selection of the third product (product ID) 25 occurs due to e.g., the detection of another critical weed type or weed species (weed ID), whereas the selection of the duty cycle rate of 75% occurs due to the detected density or size of that another critical weed type or species. What is here illustrated as a separate allocation of weed types or species (weed ID) to a particular product (product ID) also applies for the identification of a weed type or species (weed ID) and the allocation of a combination of products (product IDs).

Although not illustrated here, it is also possible to apply for a part of the products as PWFM with a reduced base cycle in order to close an application gap. A candidate for this measure may be the bottom PWM pattern for the first product 23 having a duty cycle ratio of 25%, where the gap is the largest, here 75 ms. The present BC for the first product 23 of here 100 ms may be reduced to be 50 ms. The illustrated duty cycle duration of 25 ms then reduces to 12.5 ms, so that the duty cycle ration remains 25%.

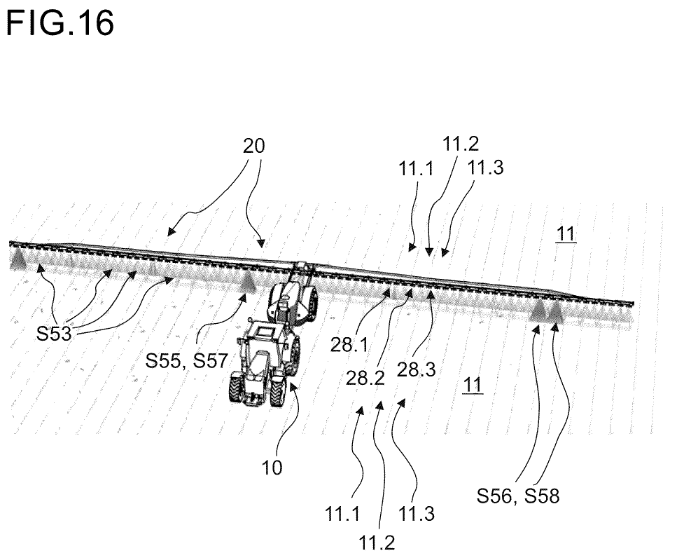

FIG. 16 illustrates a tractor of a smart farming machinery 10 a with a sprayer device 20 according to an exemplary embodiment. The sprayer 20 has a plurality of nozzles (or muzzle groups) 28.1, 28.2, 28.3, which are a respectively allocated to a sub-area 11.1, 11.2, 11.3 for treatment of that respective sub-area. The tractor moves the sprayer device 20 over the field and the area 11 to be treated.

In a first interpretation of FIG. 16, a control signal may be generated with a duty cycle corresponding to a dose rate for a first product 23, which serves for controlling the sprayer device 20, so that e.g., for all sub-areas to be treated a broadcast blanket application of a first product 23 is applied, which corresponds step S53 in FIG. 4. Upon detection of a critical weed below a threshold, the control signal may be generated with a further duty cycle corresponding to a dose rate for the first product 23, which serves for controlling the sprayer device 20, so that for particular sub-areas a spot application of a first product 23 is applied with a lower additional dose rate of the first product, which corresponds to step S55 in FIG. 4. Upon detection of a critical weed above a threshold, the control signal may be generated with a further duty cycle corresponding to a dose rate for the first product 23, which serves for controlling the sprayer device 20, so that for those particular sub-areas a spot application of a first product 23 is applied with a higher additional dose rate of the first product 23, which corresponds to step S56 in FIG. 4. It should be noted that also other thresholds may be used, e.g., based on a weed size, so that upon detection of a critical weed, e.g., a product may be applied upon exceeding a particular weed size. The dose rate may be adapted according to the detected weed size.

In a second interpretation of FIG. 16, a control signal may be generated with a duty cycle corresponding to a dose rate for a first product 23, which serves for controlling the sprayer device 20, so that e.g., for all sub-areas to be treated a broadcast blanket application of a first product 23 is applied, which corresponds step S53 in FIG. 5. Upon detection of a critical weed below a threshold, the control signal may be generated with a further duty cycle corresponding to a dose rate for the second product 24, which serves for controlling the sprayer device 20, so that for particular sub-areas a spot application of the second product 24 is applied with a lower dose rate of the second product 24, which corresponds to step S57 in FIG. 5. Upon detection of a critical weed above a threshold, the control signal may be generated with a further duty cycle corresponding to a dose rate for the second product 24, which serves for controlling the sprayer device 20, so that for those particular sub-areas a spot application of a second product 24 is applied with a higher dose rate of the second product 24, which corresponds to step S58 in FIG. 5.

In a third interpretation of FIG. 16, a control signal may be generated with a duty cycle corresponding to a dose rate for a first product 23, which serves for controlling the sprayer device 20, so that e.g., for all sub-areas to be treated a broadcast blanket application of a first product 23 is applied, which corresponds to the bottom PWM pattern in FIG. 16.

Upon detection of a critical weed, the control signal may be generated with a further duty cycle corresponding to a dose rate for the second product 24, which serves for controlling the sprayer device 20, so that for particular sub-areas a spot application of the second product 24 is applied, corresponds to the middle PWM pattern in FIG. 16. Upon detection of a further critical weed, the control signal may be generated with a further duty cycle corresponding to a dose rate for a third product 25, which serves for controlling the sprayer device 20, so that for those particular sub-areas a spot application of the third product 25 is applied corresponds to the top PWM pattern in FIG. 16.

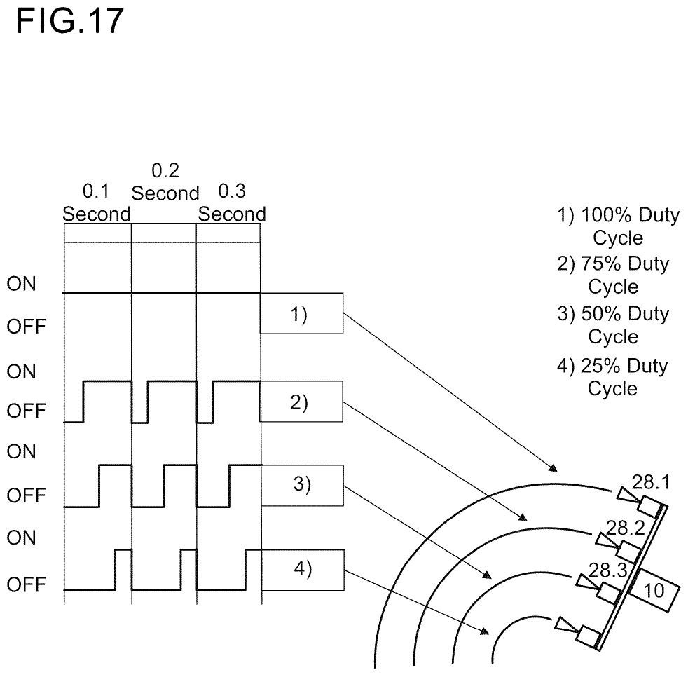

FIG. 17 illustrates the principle of a curve compensation with modification of the duty cycle duration of a PWM according to an exemplary embodiment. As can be seen from FIG. 17, the inner curve has the shortest rack length and the outer curve has the longest track line. In order to achieve that for all track lines the dame dose rate is applied, the duration of the duty cycle has to be adapted to the track length. While the machinery 10 for the longest outer track allocated to the first nozzle 28.1 applies a duty cycle ratio of 100%, the second largest track allocated to the second nozzle 28.2 should apply only a duty cycle ratio of 75%, and the third largest track allocated to the third nozzle 28.3 should apply only a duty cycle ratio of 50%. If the track allocated to the first nozzle 28.1 with a duty cycle ratio of 100% has twice the length of the track allocated to the third nozzle 28.3 with a duty cycle ratio of 50%, the total dose rate, which is the amount of product per area (equivalent to the amount of product per track length) is for both tracks the same. The same applies for the track allocated to the second nozzle 28.2 and the track allocated to the nozzle without reference.

In another exemplary embodiment of the present invention, a computer program or a computer program element is provided that is characterized by being adapted to execute the method steps of the method according to one of the preceding embodiments, on an appropriate system. The computer program element might therefore be stored on a computer unit, which might also be part of an embodiment of the present invention. This computing unit may be adapted to perform or induce a performing of the steps of the method described above. Moreover, it may be adapted to operate the components of the apparatus above described. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention

### REFERENCE LIST

10 smart farming machinery
11 agricultural area
11.1 (first) agricultural sub-area
11.2 (second) agricultural sub-area
11.3 (third) agricultural sub-area
12 connectivity system
13 weed
14 remote computing resource
16 local/field near computing resource/field management system
18 client computer/user interface devices
20 spraying device
22 sprayer housing
23 first agent/product, first agent/product tank
24 second agent/product, second agent/product tank
25 third agent/product, third agent/product tank
26 (fluidic) agent/product line
27.1 first fluid line
27.2 second fluid line
27.3 third fluid line
28 spray nozzle/group of spray nozzles/nozzle system
28.1 first spray nozzle/group of spray nozzles
28.2 second spray nozzle/group of spray nozzles
28.3 third spray nozzle/group of spray nozzles
29 fluid line
30 detection system/imaging system
31 detection components/camera/imaging device
32 control system, actor device
34 fluid sensor
36 spray monitoring system/unit
38 nozzle sensor
38.1 first nozzle sensor
38.2 second nozzle sensor
38.3 third nozzle sensor
60.1 first controllable tank valve/actor device
60.2 second controllable tank valve/actor device
60.3 third controllable tank valve/actor device
62.1 first controllable nozzle valve/actor device
62.2 second controllable nozzle valve/actor device
62.3 third controllable nozzle valve/actor device
64.1 first application nozzle
64.2 second application nozzle
64.3 third application nozzle
66 spray array
70 nozzle application area
DC1 first duty cycle/activation period
DC2 second duty cycle/activation period
OP overlap of application areas
BC1 first base cycle/clock period
BC2 second base cycle/clock period

1. A method for generating a control signal for a smart spraying device with one or more individually controllable spray nozzle(s) or groups of spray nozzles for a field treatment process, the method comprising:
receiving a vegetative indicator of an area to be treated,
determining a required dose rate for a first product for an area to be treated with a first product based on the vegetative indicator,
determining a first duty cycle (DC1) of a Pulse Width Modulation (PWM) of a control signal for application of the first product in the area to be treated based on the determined dose rate for the first product, wherein the first duty cycle is indicative of an activation duration during a duration of a first base cycle (BC1) for at least one of the individually controllable spray nozzle(s) or group of spray nozzles, and
providing the generated control signal for individually controlling said one or more spray nozzle(s) or group of spray nozzles for application of the first product.

2. The method according to claim 1,
wherein receiving a vegetative indicator of the area to be treated includes receiving location-specific field data associated with a plurality of sub-areas within the area to be treated,
wherein determining a required dose rate for a first product includes determining an individual dose rate for the respective sub-area to be treated based on the vegetative indicator associated with the respective sub-area,
wherein determining a first duty cycle (DC1) of a control signal includes determining a first duty cycle (DC1) for at least one of the individually controllable spray nozzle(s) or group of spray nozzles based on the individual dose rate for the first product for the respective sub-area, and
wherein providing the generated control signal includes providing a generated control signal for at least one of the individually controllable spray nozzle(s) or group of spray nozzles for application of the first product in the respective sub-area.

3. The method according to claim 1, further comprising:
receiving a ground speed of the at least one spray nozzle or group of spray nozzles,
wherein determining a first duty cycle (DC1) of a control signal includes determining a first duty cycle (DC1) for at least one of the individually controllable spray nozzles or group of spray nozzles for application of the first product in an area to be treated, based on the determined dose rate for a first product and the ground speed of the at least one spray nozzle or group of spray nozzles,
wherein receiving a ground speed includes receiving an individual ground speed for individual spray nozzles or groups of spray nozzles each associated with a respective sub-area, and
wherein determining a first duty cycle (DC1) of a control signal includes determining a first duty cycle (DC1) for individual spray nozzles or group of spray nozzles based on the individual dose rate for the first product for the respective sub-area and the individual ground speed of the individual spray nozzles or group of spray nozzles.

4. The method according to claim 1,
wherein the control signal per spray nozzle or spray nozzle group relates to an active-operation, if the vegetative indicator related to a specific spray nozzle or spray nozzle group is a quantitative indicator and with respect to a first threshold of the respective vegetative indicator indicates the respective sub-area to be treated with the first product.

5. The method according to claim 1,
wherein determining a first duty cycle (DC1) includes determining a first base cycle (BC1) by providing a predetermined overlap of at least two application areas in successive duty cycles (DC1) for respective sub-areas in a movement direction of the individual spray nozzle or group of spray nozzles and deriving the first base cycle (BC1) from the predetermined overlap of application areas in successive duty cycles (DC1) and the on duration of the first duty cycle (DC1) derived from the respective dose rate.

6. The method according to claim 1,
wherein the vegetative parameter includes a type or species parameter specifying a condition per sub-area and a quantitative parameter specifying a quantity of a type or species per sub-area, wherein the method further comprises selecting the first product per sub-area based on the type or species parameter, wherein determining a dose rate per sub-area is based on at least one of the type or species parameter and the quantitative parameter.

7. The method according to claim 1, wherein the vegetative indicator is derived from real time field data, wherein the field data are associated with a field condition, wherein determining a duration of the first duty cycle (DC1) is determined in real time based on the vegetative indicator per sub-area and location specific dose rates per sub-area per spray nozzle or spray nozzle group.

8. The method according to claim 1, further comprising:
determining a weed indicator per sub-area associated with a predetermined weed type and/or weed species is based on the field data of that respective sub-area,
adapting the required dose rate for a first product applied to the respective sub-area is based on the determined weed indicator.

9. The method according to claim 1, further comprising:
identifying in the vegetative indicator a particular type or species parameter specifying a particular condition per sub-area and a quantitative parameter specifying a quantity of that particular type or species per sub-area,
identifying a second product based on the identified particular type or species parameter,
determining a required dose rate for the second product for a sub-area for which in the vegetative indicator a particular type or species parameter was identified based on the identified quantitative parameter,
determining a second duty cycle (DC2) of a PWM of a control signal for application of the second product in the respective sub-area for which in the vegetative indicator a particular type or species parameter was identified based on the determined dose rate for the second product, wherein the second duty cycle (DC2) is indicative of an activation duration during a duration of a second base cycle (BC2) for at least one of the individually controllable spray nozzle(s) or spray nozzle groups associated to the sub-area for which in the vegetative indicator a particular type or species parameter was identified, and
providing the generated control signal for controlling the respective spray nozzle or spray nozzle group for the respective sub-area for application of the second product.

10. The method according to claim 9,
wherein determining a first duty cycle (DC1) includes a per sub-area related determining of a first duty cycle (DC1) based on application map field data provided prior to the field treatment process, and
wherein determining a second duty cycle (DC2) includes determining of a second duty cycle (DC2) for sub-areas for which in the vegetative indicator a particular type or species parameter was identified based on real time field data obtained during the field treatment process.

11. The method according to claim 10,
wherein upon providing the generated control signal for controlling the respective spray nozzle or spray nozzle group for application of the second product in a particular sub-area, a control signal or generation of a control signal for controlling that respective spray nozzle or spray nozzle group for application of the first product in that particular sub-area is suppressed.

12. A smart spraying device comprising
one or more individually controllable spray nozzle(s) or groups of spray nozzles,
a receiving section for receiving control signals for the one or more individually controllable spray nozzle(s) or groups of spray nozzles provided by the method according to claim 1,
an actor device for activating selectively the one or more individually controllable spray nozzle(s) or groups of spray nozzles based on the provided control signals.

13. A system comprising
a computing capacity being adapted for carrying out the method according to claim 1,
a smart spraying device comprising one or more individually controllable spray nozzle(s) or groups of spray nozzles, a receiving section for receiving control signals for the one or more individually controllable spray nozzle(s) or groups of spray nozzles provided by the method according to claim 1. an actor device for activating selectively the one or more individually controllable spray nozzle(s) or groups of spray nozzles based on the provided control signals,
wherein the receiving section and the computing capacity are communicatively connected to each other to communicate control signals.

14. A computer program product being adapted for carrying out the method according to claim 1.

15. A computer storage medium having stored there on the computer program product of claim 14.

16. The method according to claim 1, wherein the vegetative indicator is derived from image field data collected during treatment of the field.
